(19) United States
(12) Patent Application Publication
(10) Pub. No.: US 2024/0287254 A1
(43) Pub. Date: Aug. 29, 2024

(54) OPTICALLY TRANSPARENT POLYIMIDE

(71) Applicants: ZYMERGEN INC., Emeryville, CA (US); SUMITOMO CHEMICAL COMPANY, LIMITED, Tokyo (JP)

(72) Inventors: Christopher Leland MCGANN, Oakland, CA (US); Kaylie Masheid NAGHSHPOUR, San Francisco, CA (US); Arjan ZOOMBELT, San Mateo, CA (US); Kazuya MATSUI, Tokyo (JP); Satoshi OKAMOTO, Tokyo (JP)

(21) Appl. No.: 18/568,451

(22) PCT Filed: Jun. 9, 2022
(86) PCT No.: PCT/US2022/072836

§ 371 Date: Dec. 8, 2023

Related U.S. Application Data
(60) Provisional application No. 63/209,009, filed on Jun. 10, 2021.

(51) Int. Cl. C08G 73/16; C08G 73/10

(52) U.S. Cl. CPC C08G 73/16; C08G 73/1039; C08G 73/1042

(57) ABSTRACT

A polyimide material is obtained from a first monomer and a second monomer. The first monomer includes an es-ter-containing dianhydride. The second monomer includes a diamine. The polyimide material has desirable optical, structural, thermal, mechanical properties, or combination thereof.

### TECHNICAL FIELD

The present disclosure relates to optically transparent polyimides including an ester-containing dianhydride and a diamine.

### BACKGROUND ART

Organic films are high in flexibility as compared to glass, difficult to break, and lightweight. Recently, study has been performed with the aim of developing a flexible display using organic film as the substrate of a flat panel display.

Generally, resins used in organic film include polyester, polyamide, polyimide, polycarbonate, polyether sulfone, acrylic, and epoxy. Of these, polyimide resin is high in heat resistance, mechanical strength, abrasion resistance, dimensional stability, chemical resistance, insulation capability, and accordingly in wide use in the electric/electronic industries.

For use as an alternative to the glass substrate in display elements, polyimide resin is required to have high transparency and low birefringence. These properties are necessary to obtain clear images. However, manufacturing methods and current formulations provide inconsistencies in resins leading to variation in performance properties. Accordingly, there is a desire to modify the polyimide material to provide consistent and advantageous performance improvements.

### SUMMARY

Various aspects and embodiments contemplated herein may include, but are not limited to one or more of the following.

In a first aspect, a polyimide material is obtained from at least one first monomer selected from the group consisting of:

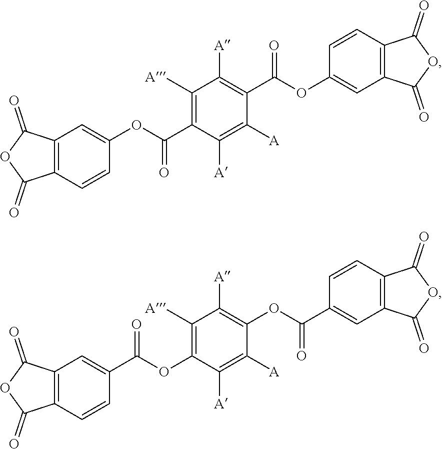

or combination thereof, wherein A, A′, A″, and A″′ is independently at each occurrence a hydrogen, an alkyl, a halogen, a haloalkyl, or combination thereof; and
at least one second monomer selected from the group consisting of:

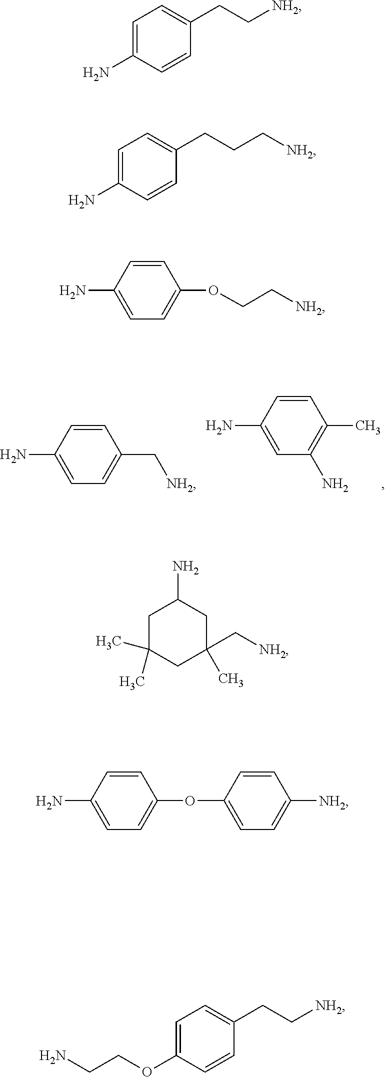

or combination thereof;
wherein the polyimide material has at least one property of:
(i) a glass transition temperature as determined by thermomechanical analysis of at least 200° C., at least 210° C., at least 220° C., at least 230° C., at least 240° C., at least 250° C., at least 260° C., at least 270° C., at least 280° C., at least 290° C., at least 300° C., at least 310° C., at least 320° C., at least 330° C., at least 340° C., at least 350° C., at least 360° C., at least 370° C., at least 380° C., at least 390° C., or at least 400° C.;
(ii) a tensile modulus as determined according to ASTM standard D897-08 of at least 2.5 GPa, at least 2.8 GPa, at least 3.0 GPa, at least 3.3 GPa, at least 3.5 GPa, at least 3.8 GPa, at least 4.0 GPa, at least 4.3 GPa, at least 4.5 GPa, at least 4.8 GPa, at least 5.0 GPa, at least 5.2 GPa, at least 5.5 GPa, at least 5.8 GPa, at least 6.0 GPa, at least 6.3 GPa, at least 6.5 GPa, at least 6.8 GPa, at least 7.0 GPa, at least 7.3 GPa, or at least 7.5 GPa;
(iii) a Yellow Index according to ASTM E313 of a film having a thickness of 25 micrometer (±5 micrometer) of the polyimide material of not more than 40.0, not more than 35.0, not more than 30, not more than 25.0, not more than 20.0, not more than 15.0, not more than 10.0, not more than 8.0, not more than 5.0, not more than 4.0, not more than 3.5, not more than 3.2, not more than 3.0, not more than 2.8, not more than 2.6, not more than 2.4, not more than 2.2, not more than 2.0, not more than 1.8, not more than 1.6, or not more than 1.4; or
(iv) a haze as determined according to ASTM D1003-13 of a film having a thickness of 25 micrometer (±5 micrometer) of the polyimide material of not greater than 1.5%, not greater than 1.3%, not greater than 1.1%, not greater than 1.0%, not greater than 0.8%, not greater than 0.6%, not greater than 0.5%, not greater than 0.4%, or not greater than 0.3%.

In another aspect, a polyimide material includes a moiety selected from:

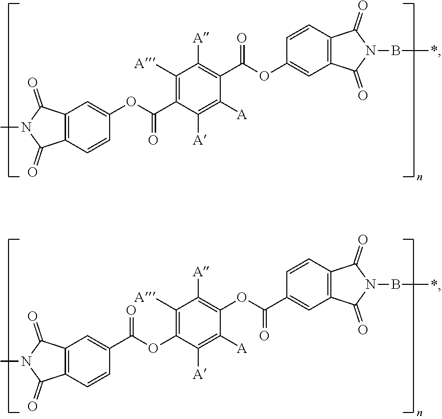

or combination thereof, wherein n is an integer greater than 1, wherein A, A′, A″, and A″′ is independently at each occurrence a hydrogen, an alkyl, a halogen, a haloalkyl, or combination thereof, with the proviso that at least one of A, A′, A″, and A″′ includes an alkyl, a halogen, a haloalkyl, or combination thereof; and
wherein B is selected from the group consisting of:

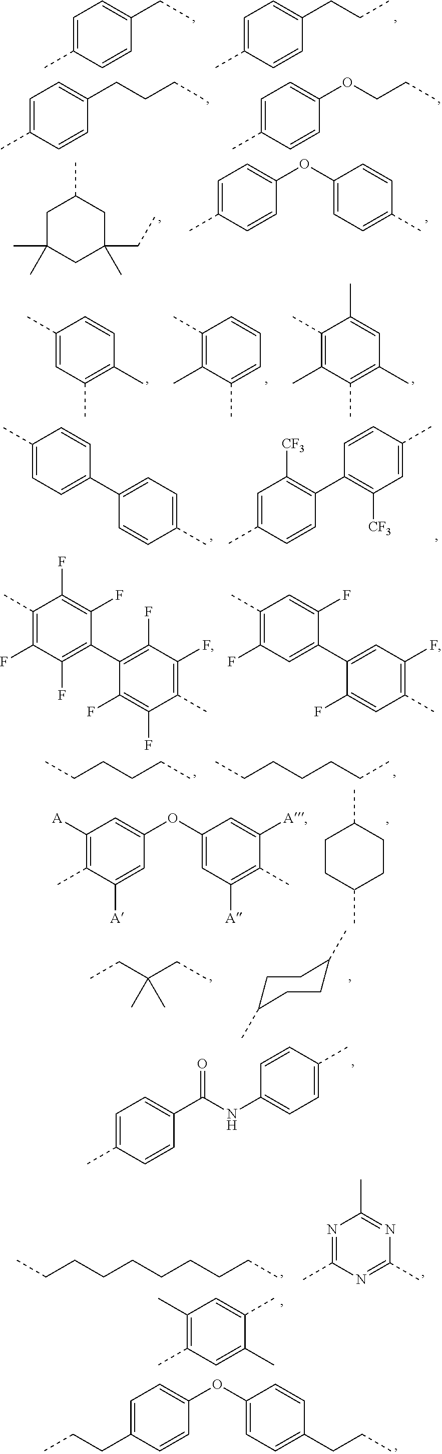

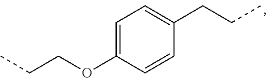

or combination thereof, wherein A, A′, A″, and A″′ is independently at each occurrence a hydrogen, an alkyl, a halogen, a haloalkyl, or combination thereof.

### DETAILED DESCRIPTION OF THE PREFERRED EMBODIMENT(S)

The following description is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

As used herein, the terms “comprises”, “comprising”, “includes”, “including”, “has”, “having” or any other variation thereof, are open-ended terms and should be interpreted to mean “including, but not limited to . . . .” These terms encompass the more restrictive terms “consisting essentially of” and “consisting of.” In an embodiment, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in reference books and other sources within the structural arts and corresponding manufacturing arts. Unless indicated otherwise, all measurements are at about 23° C.+/−5° C. per ASTM, unless indicated otherwise.

As described above, a polyimide material may be obtained from at least a first monomer and a second monomer. In an embodiment, the at least one first monomer includes an ester-containing dianhydride. In an embodiment, the at least one second monomer includes a diamine. The polyimide material has desirable optical properties, structural properties, thermal properties, mechanical properties, or combination thereof.

In a particular embodiment, the at least one first monomer is selected from the group consisting of:

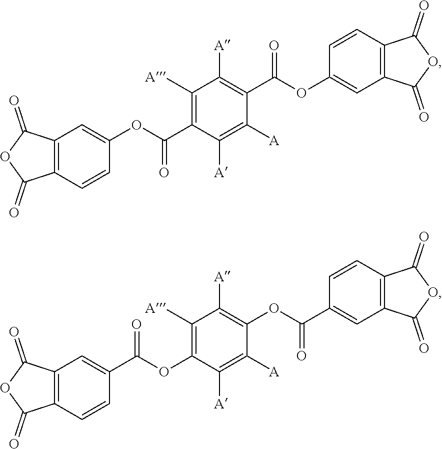

combination thereof. For each of the first monomers, the moieties A, A′, A″, and A″′, can be selected independently for each occasion. A, A′, A″, and A″′ is independently at each occurrence a hydrogen, an alkyl, a halogen, a haloalkyl, or combination thereof. In one embodiment, A, A′, A″, and A″′ are different. In an embodiment, the alkyl, haloalkyl, or combination thereof includes a C1-C20 hydrocarbon group, a C1-C20 halogenated hydrocarbon group, or a C1-C20 perhalogenated group. “Perhalogenated” as used herein includes an alkyl group where all the hydrogen atoms are substituted with a halogen atom. For instance, a perfluoroalkyl is CF₃(CF₂)ₙ— where n is selected from any integer or zero. In a particular embodiment, at least one of A, A′, A″, and A″′ includes an alkyl group, haloalkyl, or halogen. The haloalkyl, halogen, or combination thereof includes fluorine, chlorine, bromine, iodine, or combination thereof. In an embodiment, the haloalkyl, halogen, or combination thereof includes fluorine. In a particular embodiment, at least one of A, A′, A″, and A″′ includes a halogen and, more particularly, a fluorine.

In one embodiment, the first monomer can be selected from:

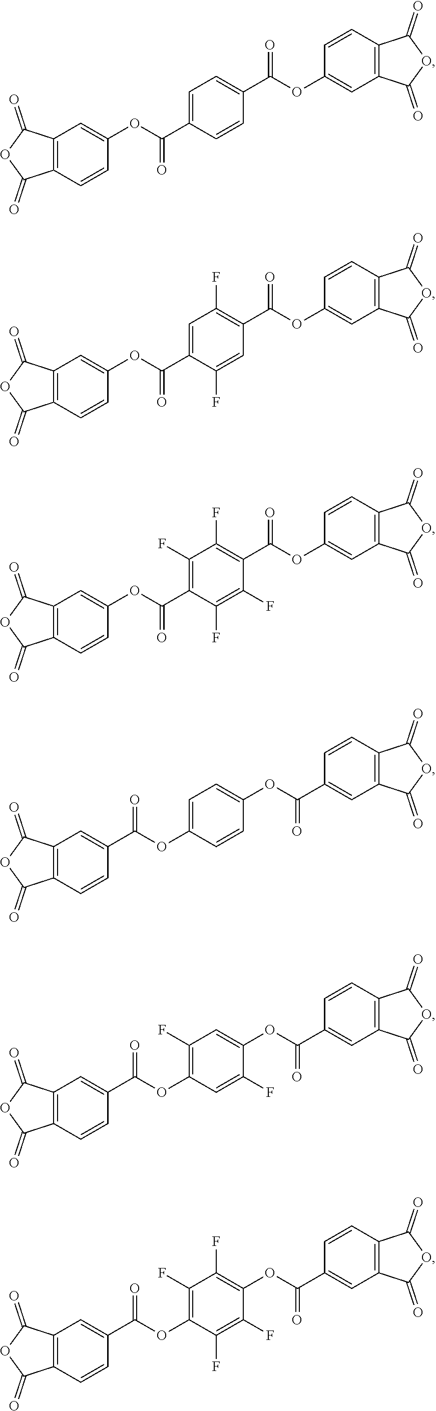 [SMILES: O=C(Oc1ccc2c(c1)C(=O)OC2=O)c1ccc(C(=O)Oc2ccc3c(c2)C(=O)OC3=O)cc1 ; O=C(Oc1ccc2c(c1)C(=O)OC2=O)c1cc(F)c(C(=O)Oc2ccc3c(c2)C(=O)OC3=O)cc1F ; O=C1OC(=O)c2cc(OC(=O)c3c(F)c(F)c(C(=O)Oc4ccc5c(c4)C(=O)OC5=O)c(F)c3F)ccc21 ; O=C(Oc1ccc(OC(=O)c2ccc3c(c2)C(=O)OC3=O)cc1)c1ccc2c(c1)C(=O)OC2=O ; O=C(Oc1cc(F)c(OC(=O)c2ccc3c(c2)C(=O)OC3=O)cc1F)c1ccc2c(c1)C(=O)OC2=O ; O=C(Oc1c(F)c(F)c(OC(=O)c2ccc3c(c2)C(=O)OC3=O)c(F)c1F)c1ccc2c(c1)C(=O)OC2=O]

or any combination thereof.

In an embodiment, the polyimide material includes at least one second monomer. The at least one second monomer includes any reasonable diamine. In an embodiment, the at least one second monomer is selected from the group consisting of:

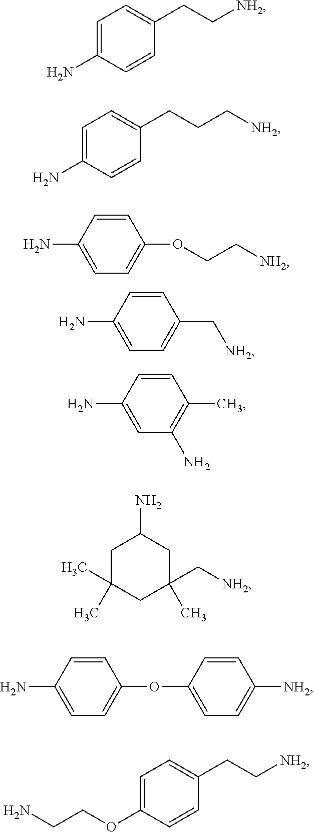

or combination thereof.

In a particular embodiment, the at least one second monomer is selected from the group consisting of:

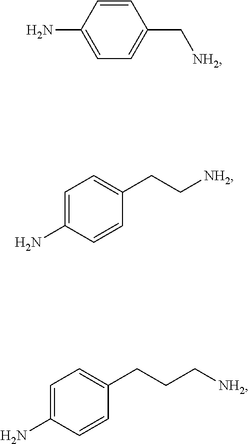 [SMILES: NCc1ccc(N)cc1 ; NCCc1ccc(N)cc1 ; NCCCc1ccc(N)cc1]

or combination thereof.

In a particular embodiment, the second monomer can be selected from 4-aminobenzylamine (4-AMA), 4-aminophenylpropylamine (4-APPA), 4-aminoethoxyphenylethylamine (4-AEPEA), or 4-aminophenylethylamine (4-APEA). In one further embodiment, the second monomer consists essentially of 4-APEA. In an embodiment, the second monomer consists of 4-APEA.

In an embodiment, the polyimide material that is obtained from the at least first monomer and the second monomer has advantageous properties. For instance, the polyimide material has at least one property of an advantageous glass transition temperature, a tensile modulus, a Yellow Index, haze, or combination thereof. Any combination of the properties is envisioned. In an embodiment, the combination includes at least two properties, at least three properties, or even all four properties.

In an example, the polyimide material has a glass transition temperature as determined by thermomechanical analysis of at least 200° C., at least 210° C., at least 220° C., at least 230° C., at least 240° C., at least 250° C., at least 260° C., at least 270° C., at least 280° C., at least 290° C., at least 300° C., at least 310° C., at least 320° C., at least 330° C., at least 340° C., at least 350° C., at least 360° C., at least 370° C., at least 380° C., at least 390° C., or at least 400° C.

In an example, the polyimide material has a tensile modulus as determined according to ASTM standard D897-08 of at least 2.5 GPa, at least 2.8 GPa, at least 3.0 GPa, at least 3.3 GPa, at least 3.5 GPa, at least 3.8 GPa, at least 4.0 GPa, at least 4.3 GPa, at least 4.5 GPa, at least 4.8 GPa, at least 5.0 GPa, at least 5.2 GPa, at least 5.5 GPa, at least 5.8 GPa, at least 6.0 GPa, at least 6.3 GPa, at least 6.5 GPa, at least 6.8 GPa, at least 7.0 GPa, at least 7.3 GPa, or at least 7.5 GPa.

In an embodiment, the polyimide material has a Yellow Index according to ASTNM E313 of a film having a thickness of 25 micrometer (±5 micrometer) of the polyimide material of not more than 40.0, not more than 35.0, not more than 30, not more than 25.0, not more than 20.0, not more than 15.0, not more than 10.0, not more than 8.0, not more than 5.0, not more than 4.0, not more than 3.5, not more than 3.2, not more than 3.0, not more than 2.8, not more than 2.6, not more than 2.4, not more than 2.2, not more than 2.0, not more than 1.8, not more than 1.6, or not more than 1.4.

In an embodiment, the polyimide material has a haze as determined according to ASTM D1003-13 of a film having a thickness of 25 micrometer (±5 micrometer) of the polyimide material of not greater than 1.5%, not greater than 1.3%, not greater than 1.1%, not greater than 1.0%, not greater than 0.8%, not greater than 0.6%, not greater than 0.5%, not greater than 0.4%, or not greater than 0.3%.

In addition to the aforementioned properties, the polyimide material may have at least one property selected from the following property group M. In another embodiment, the polyimide material has at least two, at least three, or at least four properties selected from the following property group M. The property group M refers to structural, thermal, or mechanical properties and can include, for example:
(i) a tensile strength of the polyimide material as determined according to ASTM standard D897-08 of at least 2.5 GPa, at least 2.8 GPa, at least 3.0 GPa, at least 3.3 GPa, at least 3.5 GPa, at least 3.8 GPa, at least 4.0 GPa, at least 4.3 GPa, at least 4.5 GPa, at least 4.8 GPa, or at least 5.0 GPa;
(ii) a peak molecular weight as determined by size exclusion chromatography against a polystyrene standard of at least 200 kDa, at least 250 kDa, at least 300 kDa, at least 350 kDa, at least 400 kDa, at least 450 kDa, at least 500 kDa, at least 550 kDa, at least 600 kDa, at least 650 kDa, or at least 700 kDa;
(iii) an elongation at break of a film having a thickness of 25 micrometer (±5 micrometer) of the polyimide material as determined by ASTM D638-14 of not more than 20%, not more than 17%, not more than 15%, not more than 13%, not more than 10%, not more than 9.5%, not more than 9%, not more than 8.5%, not more than 8%, not more than 7.5%, not more than 7%, not more than 6.5%, not more than 6.2%, not more than 6.0%, not more than 5.8%, not more than 5.6%, not more than 5.4%, not more than 5.2%, not more than 5%, or not more than 4.8%; or
(iv) a folding endurance of a film having a thickness of 25 micrometer (±5 micrometer) of the polyimide material as determined according to ASTM D2176-16 over a pin having a radius of 1 mm of at least 10,000 folds, at least 20,000 folds, at least 50,000 folds, at least 80,000 folds, at least 100,000 folds, at least 150,000 folds, at least 180,000 folds, at least 200,000 folds, at least 250,000 folds, at least 300,000 folds, at least 500,000 folds, or at least 1,000,000 folds.

Furthermore, the polyimide can have at least one property selected from the following property group O. In another embodiment, the polyimide material has at least two, at least three, or at least four properties selected from the following property group O. The property group O refers predominately to optical properties and can include, for example: (i) an optical transparency of a film having a thickness of 25 micrometer (±5 micrometer) of the polyimide material as determined by UV-Vis spectroscopy at 400 nm of at least 20%, at least 25%, at least 30%, at least 32%, at least 34%, at least 36%, at least 38%, at least 40%, at least 42%, or at least 44%;
(ii) an optical transparency of a film having a thickness of 25 micrometer (±5 micrometer) of the polyimide material as determined by UV-Vis spectroscopy at 550 nm of at least 85%, at least 86%, at least 87%, at least 88%, at least 89%, at least 90%, at least 91%, at least 92%, at least 94%, or at least 96%;
(iii) an optical transparency of a film having a thickness of 25 micrometer (±5 micrometer) of the polyimide material as determined by UV-Vis spectroscopy at 330 nm of not greater than 50%, not greater than 48%, not greater than 46%, not greater than 44%, not greater than 42%, not greater than 40%, not greater than 38%, not greater than 36%, not greater than 34%, not greater than 32%, not greater than 30%, not greater than 28%, not greater than 26%, not greater than 24%, not greater than 22%, not greater than 20%, not greater than 18%, or not greater than 16%; or
(iv) a thickness retardation Rₜₕ of not more than 200 nanometers (nm), not more than 180 nm, not more than 160 nm, not more than 140 nm, not more than 120 nm, not more than 100 nm, not more than 80 nm, not more than 60 nm, not more than 50 nm, not more than 40 nm, not more than 30 nm, not more than 28 nm, not more than 26 nm, not more than 24 nm, not more than 22 nm, or not more than 20 nm.

Accordingly, any combination of the number of properties of each property group M and O is considered within the scope of the disclosure.

In one embodiment, the polyimide material further includes an optional third monomer. The optional third monomer typically includes at least one amino group, and in an embodiment, at least two amino groups. For instance, the optional third monomer may include any reasonable diamine. In an embodiment, the optional third monomer may be at least one diamine selected from the group consisting of:

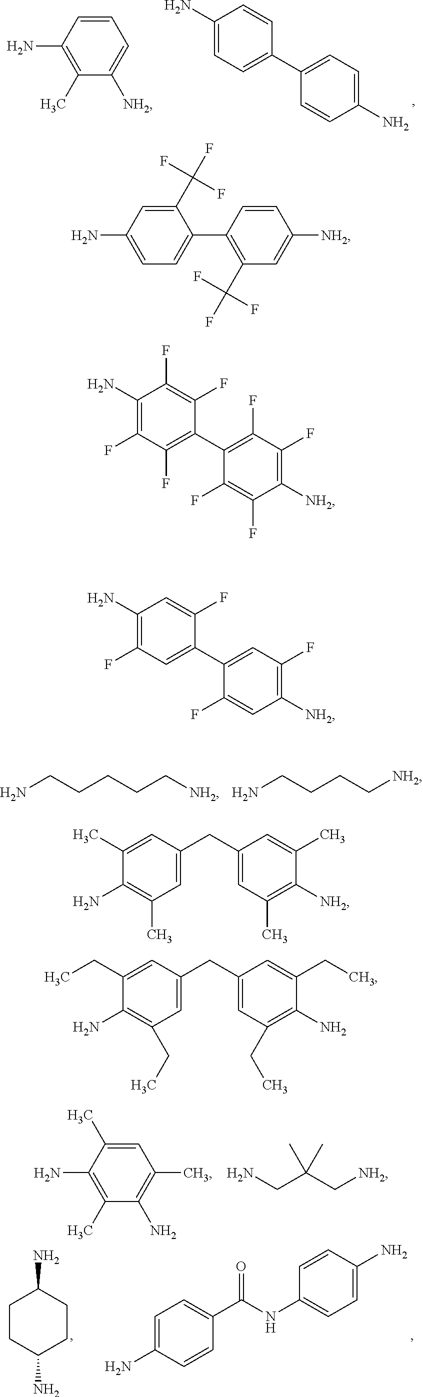

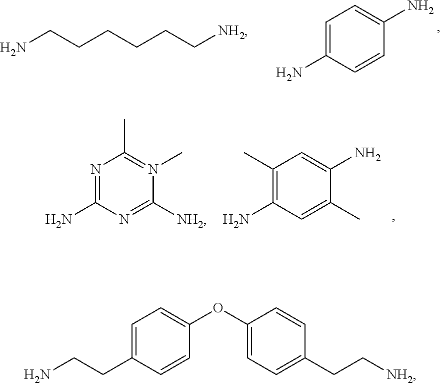

or combination thereof.

In one further embodiment, the diamine can be selected from any asymmetric diamine. An asymmetric diamine comprises two amino groups that have different reactivity in the imidization reaction. For instance, one amine can be a primary aliphatic amine, and the second can be an aromatic amine. In one additional embodiment, the diamine can be sourced via fermentation from a microbial host.

In yet another embodiment, an optional fourth monomer may be included in the polyimide material. For instance, the optional fourth monomer includes an additional dianhydride. In an example, the optional fourth monomer is at least one dianhydride selected from the group consisting of:

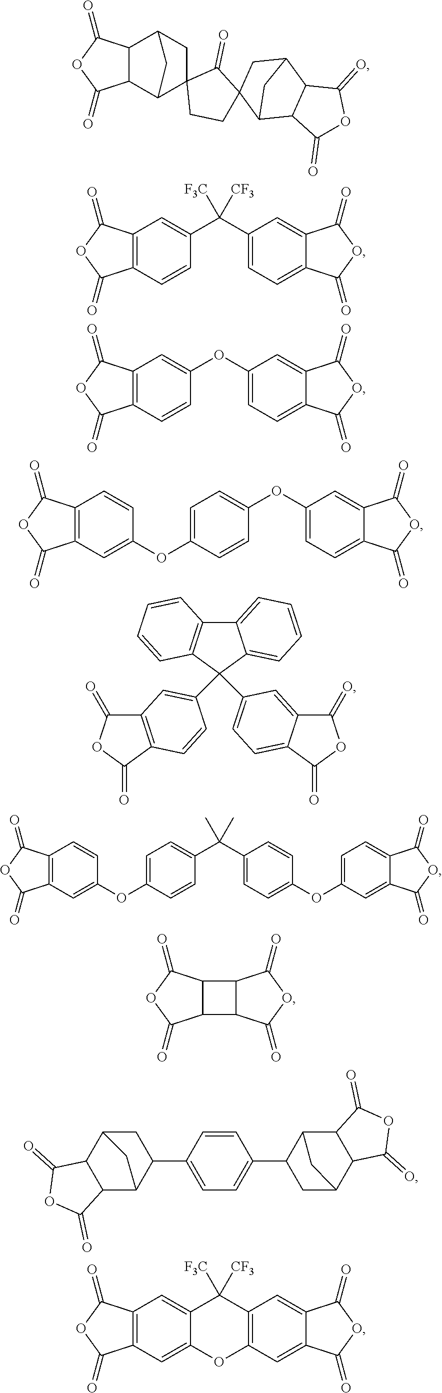

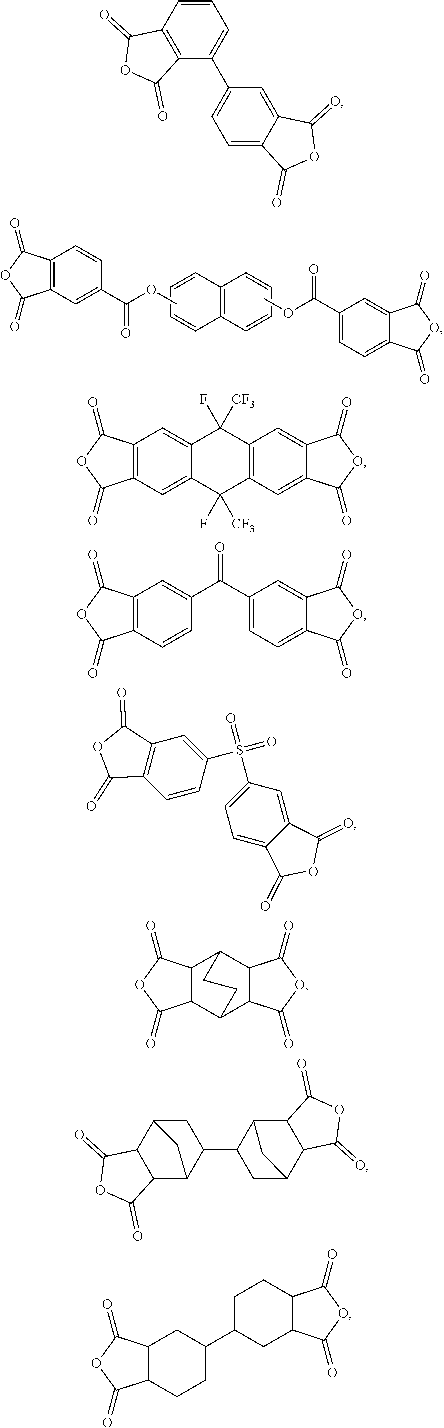

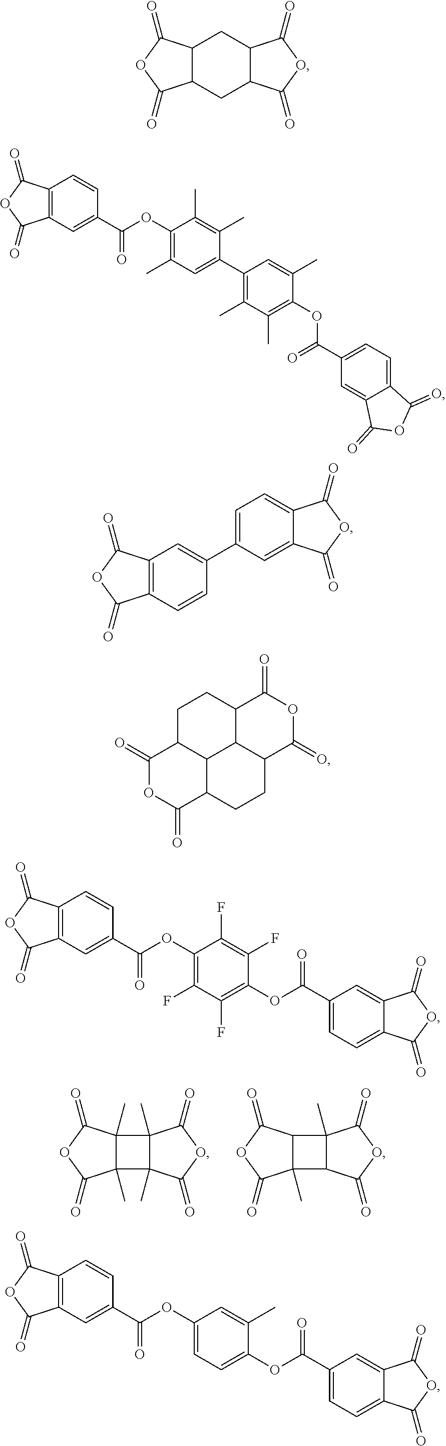

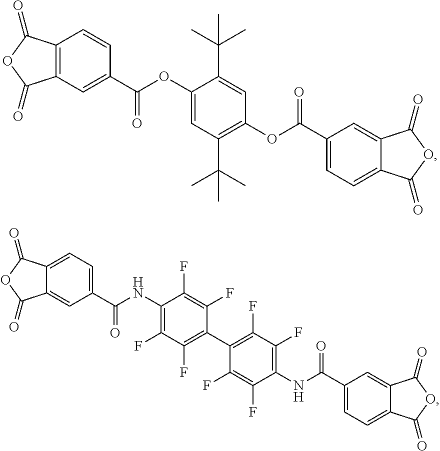 [SMILES: CC(C)(C)c1cc(OC(=O)c2ccc3c(c2)C(=O)OC3=O)c(C(C)(C)C)cc1OC(=O)c1ccc2c(c1)C(=O)OC2=O ; O=C(Nc1c(F)c(F)c(-c2c(F)c(F)c(NC(=O)c3ccc4c(c3)C(=O)OC4=O)c(F)c2F)c(F)c1F)c1ccc2c(c1)C(=O)OC2=O]

In yet one further embodiment, the fourth monomer can include a tri-valent carboxy compound which results in an amido-imide function within the polymer. For example the group of forth monomers can further include:

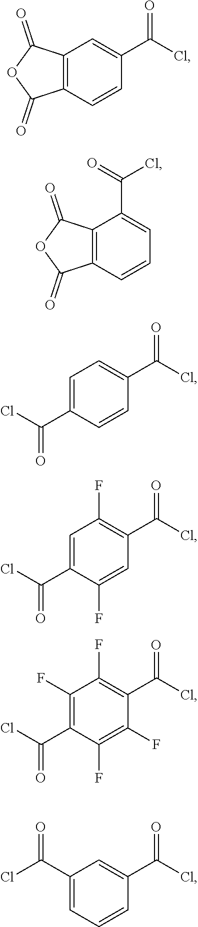

or any combination.

In one embodiment, the first monomer and the second monomer can be in any molar ratio. The molar ratio of the first monomer:second monomer can range from 10:1 to 1:10, from 5:1 to 1:5, from 3:1 to 1:3, from 2:1 to 1:2, from 3:2 to 2:3, from 4:3 to 3:4, from 5:4 to 4:5, from 6:5 to 5:6, from 7:6 to 6:7, from 8:7 to 7:8, from 9:8 to 8:9, or from 10:9 to 9:10. In one embodiment, the first monomer is in the majority.

In an embodiment, the polyimide material may include the optional monomers such as a third, a fourth, and further monomers. For such multiple monomeric systems, the molar ratio of first to the sum of all other monomers can range from 10:1 to 1:10, from 5:1 to 1:5, from 3:1 to 1:3, from 2:1 to 1:2, from 3:2 to 2:3, from 4:3 to 3:4, from 5:4 to 4:5, from 6:5 to 5:6, from 7:6 to 6:7, from 8:7 to 7:8, from 9:8 to 8:9, or from 10:9 to 9:10.

In one embodiment, derivatives of the first monomer, the second monomer, or the optional monomers are within the scope of this disclosure. For instance, any reactive derivative of the first monomer is considered within the scope of the present disclosure. For example, any ester of the dianhydrides, such as mono-, di-, tri-, and tetraesters are considered. In another embodiment, any salt of the foregoing diamines are considered.

In an embodiment, the polyimide material is the reactive product of the first monomer, the second monomer, and any optional monomers. For instance, the polyimide material may be obtainable from the first monomer, the second monomer, and any optional monomers. In an embodiment, the polyimide material is obtained by reacting the ester-containing dianhydride of the first monomer with the diamine of the second monomer with any optional monomer included during the reaction. Any reaction conditions are considered and exemplary methods include, but are not limited to, those are described below in the Examples. In an embodiment, the reaction conditions may be at lower temperatures not yet before used for chemical imidization. Further, the monomers are relatively soluble, an advantage over prior systems where insolubility of the polyimide components have been problematic.

In an embodiment, the polyimide material includes a moiety selected from:

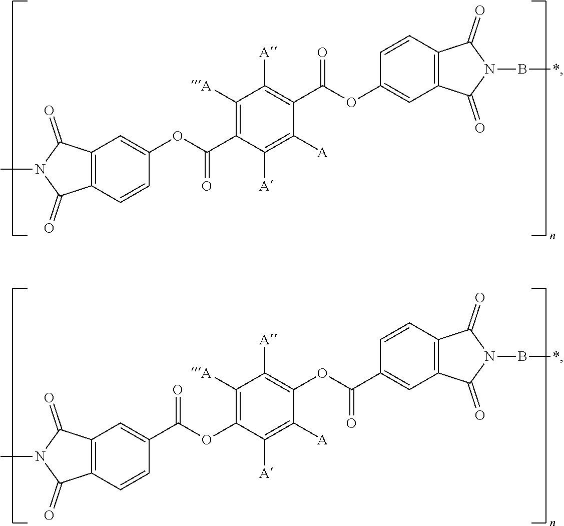

or combination thereof.

Parameter n is an integer greater than 1. For each of the first monomers, the moieties A, A′, A″, and A″′ can be selected independently for each occasion. A, A′, A″, and A″′ is independently at each occurrence a hydrogen, an alkyl, a halogen, a haloalkyl, or combination thereof. In one embodiment, A, A′, A″, and A″′ are different. In a particular embodiment, at least one of A, A′, A″, and A″′ includes an alkyl group, haloalkyl, or halogen. In an embodiment, the alkyl, haloalkyl, or combination thereof includes a C1-C20 hydrocarbon group, a C1-C20 halogenated hydrocarbon group, or a C1-C20 perhalogenated group. The haloalkyl, halogen, or combination thereof includes fluorine, chlorine, bromine, iodine, or combination thereof. In an embodiment, the haloalkyl, halogen, or combination thereof includes fluorine. In a particular embodiment, at least one of A, A′, A″, and A″′ includes a halogen and, more particularly, a fluorine.

With respect to B of the moiety, B may be selected from the group consisting of:

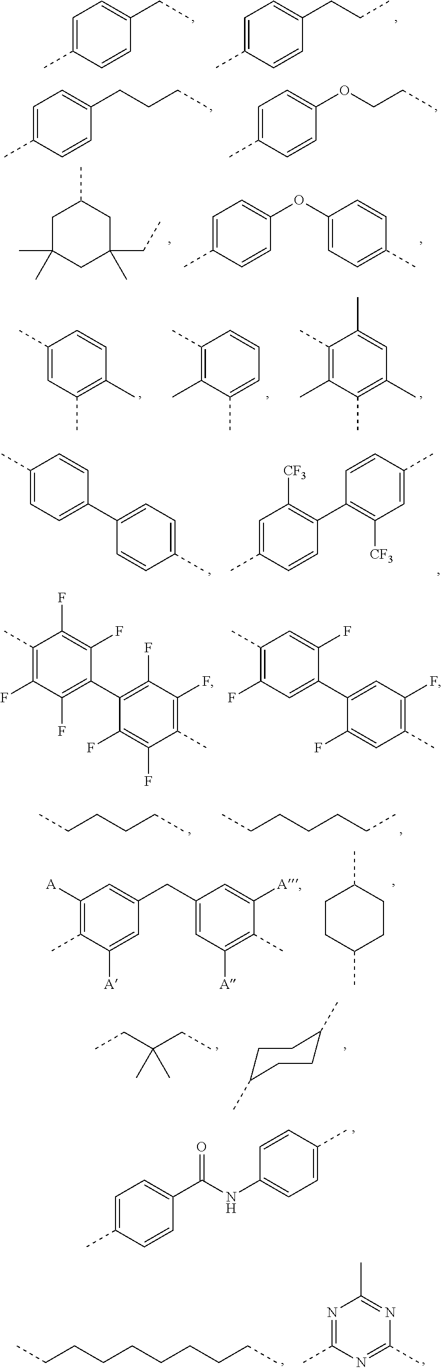

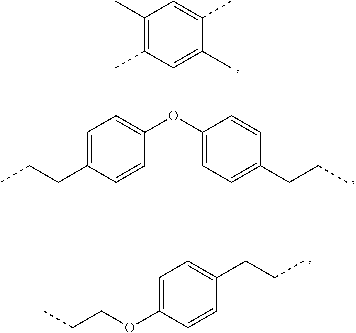

or combination thereof, where A, A′, A″, and A″′ are defined above as independently at each occurrence a hydrogen, an alkyl, a halogen, a haloalkyl, or combination thereof.

In yet another embodiment, B can be selected independently for each occasion from the group consisting of:

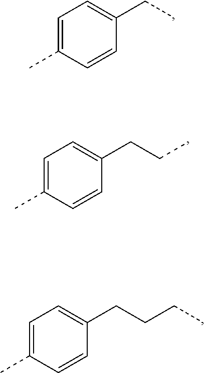

or combination thereof.

Moreover in another embodiment, the polyimide material includes:

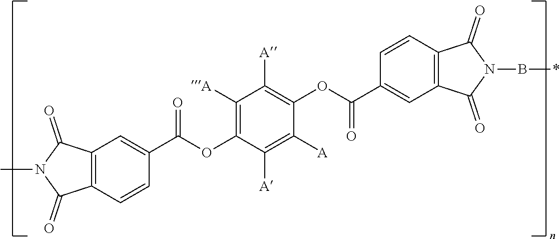

where at least one of A, A′, A″, and A″′ includes an alkyl group, haloalkyl, or halogen, n is an integer greater than 1, and B is selected from the group consisting of:

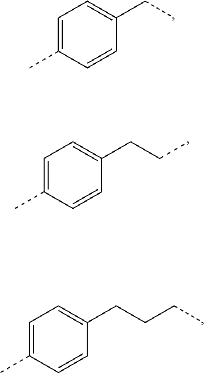

or combination thereof. In an embodiment, the haloalkyl group or halogen includes fluorine.

In another embodiment, the polyimide material includes:

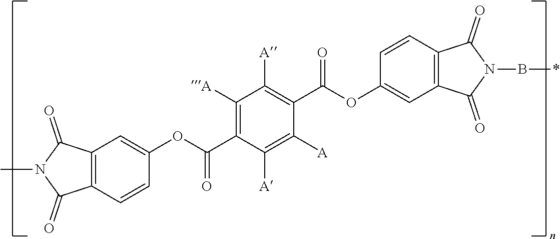

where at least one of A, A′, A″, and A″′ includes an alkyl group, haloalkyl, or halogen, n is an integer greater than 1, and B is selected from the group consisting of:

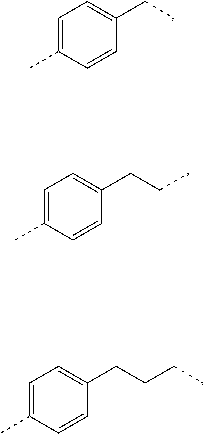

or combination thereof. In an embodiment, the haloalkyl group or halogen includes fluorine.

In an embodiment, the polyimide material containing the moiety as described above has at least one property selected from the following property group M and at least one property selected from the following property group O. The property group M includes:
(i) a glass transition temperature as determined by thermomechanical analysis of at least 200° C., at least 210° C., at least 220° C., at least 230° C., at least 240° C., at least 250° C., at least 260° C., at least 270° C., at least 280° C., at least 290° C., at least 300° C., at least 310° C., at least 320° C., at least 330° C., at least 340° C., at least 350° C., at least 360° C., at least 370° C., at least 380° C., at least 390° C., or at least 400° C.;
(ii) a tensile modulus as determined according to ASTM standard D897-08 of at least 2.5 GPa, at least 2.8 GPa, at least 3.0 GPa, at least 3.3 GPa, at least 3.5 GPa, at least 3.8 GPa, at least 4.0 GPa, at least 4.3 GPa, at least 4.5 GPa, at least 4.8 GPa, at least 5.0 GPa, at least 5.2 GPa, at least 5.5 GPa, at least 5.8 GPa, at least 6.0 GPa, at least 6.3 GPa, at least 6.5 GPa, at least 6.8 GPa, at least 7.0 GPa, at least 7.3 GPa, or at least 7.5 GPa;
(iii) a tensile strength as determined according to ASTM standard D897-08 of at least 2.5 GPa, at least 2.8 GPa, at least 3.0 GPa, at least 3.3 GPa, at least 3.5 GPa, at least 3.8 GPa, at least 4.0 GPa, at least 4.3 GPa, at least 4.5 GPa, at least 4.8 GPa, or at least 5.0 GPa;
(iv) a peak molecular weight as determined by size exclusion chromatography against a polystyrene standard of at least 200 kDa, at least 250 kDa, at least 300 kDa, at least 350 kDa, at least 400 kDa, at least 450 kDa, at least 500 kDa, at least 550 kDa, at least 600 kDa, at least 650 kDa, or at least 700 kDa;
(v) an elongation at break of a film having a thickness of 25 micrometer (±5 micrometer) of the polyimide material as determined by ASTM D638-14 of not more than 20%, not more than 17%, not more than 15%, not more than 13%, not more than 10%, not more than 9.5%, not more than 9%, not more than 8.5%, not more than 8%, not more than 7.5%, not more than 7%, not more than 6.5%, not more than 6.2%, not more than 6.0%, not more than 5.8%, not more than 5.6%, not more than 5.4%, not more than 5.2%, not more than 5%, or not more than 4.8%; or
(vi) a folding endurance of a film having a thickness of 25 micrometer (±5 micrometer) of the polyimide material as determined according to ASTM D2176-16 at a radius of 1 mm of at least 10,000 folds, at least 20,000 folds, at least 50,000 folds, at least 80,000 folds, at least 100,000 folds, at least 150,000 folds, at least 180,000 folds, at least 200,000 folds, at least 250,000 folds, at least 300,000 folds, at least 500,000 folds, or at least 1,000,000 folds.

In one embodiment, the polyimide material according to any one of the embodiments discussed herein can have at least two, at least three, or at least four properties of property group M.

As discussed above, the property group O can include:
(i) an optical transparency of a film having a thickness of 25 micrometer (±5 micrometer) of the polyimide material as determined by UV-Vis spectroscopy at 400 nm of at least 20%, at least 25%, at least 30%, at least 32%, at least 34%, at least 36%, at least 38%, at least 40%, at least 42%, or at least 44%;
(ii) an optical transparency of a film having a thickness of 25 micrometer (±5 micrometer) of the polyimide material as determined by UV-Vis spectroscopy at 550 nm of at least 85%, at least 86%, at least 87%, at least 88%, at least 89%, at least 90%, at least 91%, at least 92%, at least 94%, or at least 96%;
(iii) an optical transparency of a film having a thickness of 25 micrometer (±5 micrometer) of the polyimide material as determined by UV-Vis spectroscopy at 330 nm of not greater than 50%, not greater than 48%, not greater than 46%, not greater than 44%, not greater than 42%, not greater than 40%, not greater than 38%, not greater than 36%, not greater than 34%, not greater than 32%, not greater than 30%, not greater than 28%, not greater than 26%, not greater than 24%, not greater than 22%, not greater than 20%, not greater than 18%, or not greater than 16%;
(iv) a thickness retardation Ra of not more than 200 nanometers (nm), not more than 180 nm, not more than 160 nm, not more than 140 nm, not more than 120 nm, not more than 100 nm, not more than 80 nm, not more than 60 nm, not more than 50 nm, not more than 40 nm, not more than 30 nm, not more than 28 nm, not more than 26 nm, not more than 24 nm, not more than 22 nm, or not more than 20 nm;
(v) a Yellow Index according to ASIM E313 of a film having a thickness of 25 micrometer (±5 micrometer) of the polyimide material of not more than 40.0, not more than 35.0, not more than 30, not more than 25.0, not more than 20.0, not more than 15.0, not more than 10.0, not more than 8.0, not more than 5.0, not more than 4.0, not more than 3.5, not more than 3.2, not more than 3.0, not more than 2.8, not more than 2.6, not more than 2.4, not more than 2.2, not more than 2.0, not more than 1.8, not more than 1.6, or not more than 1.4; or
(vi) a haze as determined according to ASTM D1003-13 of a film having a thickness of 25 micrometer (±5 micrometer) of the polyimide material of not greater than 1.5%, not greater than 1.3%, not greater than 1.1%, not greater than 1.0%, not greater than 0.8%, not greater than 0.6%, not greater than 0.5%, not greater than 0.4%, or not greater than 0.3%.

In one embodiment, the polyimide material according to any one of the embodiments recited herein can have at least two, at least three, or at least four properties of property group O.

In one embodiment, the polyimide material has at least two, at least three, or at least four properties of the property group M. In another embodiment, the polyimide material has at least two, at least three, or at least four properties of the property group O. For example, in one embodiment, the polyimide material has at least two properties from property group M and at least two properties from property group O. Accordingly, any combination of the number of properties of each property group is considered within the scope of the disclosure.

Advantageously, the polyimide material may be used for any applications where the aforementioned mechanical and/or optical properties are desired. Films of any thickness are envisioned. In an embodiment, the film has a thickness of up to 150 microns. Polyimide films of the present invention can be applied in a broad spectrum of commercial industry ranging from the optical industry, electronic industry, computer industry, phone industry, automotive industry, telecommunication industry, films for the solar industry, and the like. For instance, an optical stack may include the polyimide material. In an example, the optical stack may include at least one film layer of the polyimide material. In an embodiment, an electronic device may include the polyimide material.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the items as listed below.

Embodiment 1. A polyimide material obtained from at least one first monomer selected from the group consisting of:

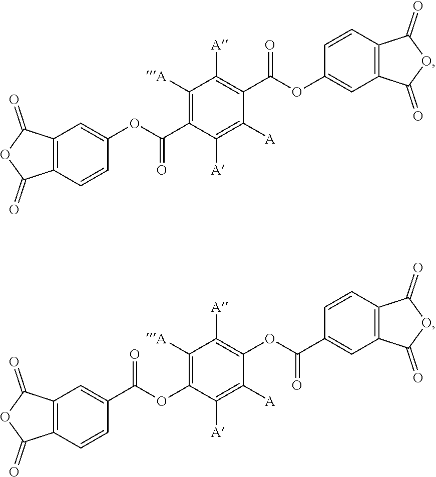

or combination thereof, wherein A, A′, A″, and A″′ is independently at each occurrence a hydrogen, an alkyl, a halogen, a haloalkyl, or combination thereof; and
a second monomer selected from the group consisting of:

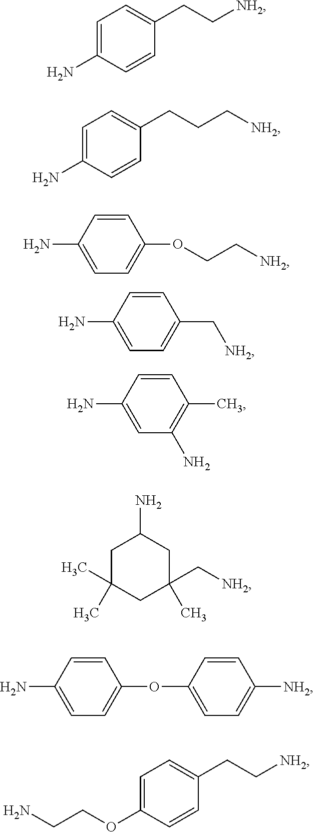

or combination thereof;
wherein the polyimide material has at least one property of:
(i) a glass transition temperature as determined by thermomechanical analysis of at least 200° C., at least 210° C., at least 220° C., at least 230° C., at least 240° C., at least 250° C., at least 260° C., at least 270° C., at least 280° C., at least 290° C., at least 300° C., at least 310° C., at least 320° C., at least 330° C., at least 340° C., at least 350° C., at least 360° C., at least 370° C., at least 380° C., at least 390° C., or at least 400° C.;
(ii) a tensile modulus as determined according to ASTM standard D897-08 of at least 2.5 GPa, at least 2.8 GPa, at least 3.0 GPa, at least 3.3 GPa, at least 3.5 GPa, at least 3.8 GPa, at least 4.0 GPa, at least 4.3 GPa, at least 4.5 GPa, at least 4.8 GPa, at least 5.0 GPa, at least 5.2 GPa, at least 5.5 GPa, at least 5.8 GPa, at least 6.0 GPa, at least 6.3 GPa, at least 6.5 GPa, at least 6.8 GPa, at least 7.0 GPa, at least 7.3 GPa, or at least 7.5 GPa;
(iii) a Yellow Index according to ASTM E313 of a film having a thickness of 25 micrometer (±5 micrometer) of the polyimide material of not more than 40.0, not more than 35.0, not more than 30, not more than 25.0, not more than 20.0, not more than 15.0, not more than 10.0, not more than 8.0, not more than 5.0, not more than 4.0, not more than 3.5, not more than 3.2, not more than 3.0, not more than 2.8, not more than 2.6, not more than 2.4, not more than 2.2, not more than 2.0, not more than 1.8, not more than 1.6, or not more than 1.4; or
(iv) a haze as determined according to ASTM D1003-13 of a film having a thickness of 25 micrometer (±5 micrometer) of the polyimide material of not greater than 1.5%, not greater than 1.3%, not greater than 1.1%, not greater than 1.0%, not greater than 0.8%, not greater than 0.6%, not greater than 0.5%, not greater than 0.4%, or not greater than 0.3%.

Embodiment 2. The polyimide material according to embodiment 1, wherein the alkyl, haloalkyl, or combination thereof includes a C1-C20 hydrocarbon group, a C1-C20 halogenated hydrocarbon group, or a C1-C20 perhalogenated group.

Embodiment 3. The polyimide material according to any of the preceding embodiments, wherein at least one of A, A′, A″, and A″′ includes an alkyl group, haloalkyl, or halogen.

Embodiment 4. The polyimide material according to any of the preceding embodiments, wherein the halogen, haloalkyl, or combination thereof includes fluorine, chlorine, bromine, iodine, or combination thereof.

Embodiment 5. The polyimide material according to any of the preceding embodiments, wherein the haloalkyl includes a C1-C20 hydrocarbon group including fluorine.

Embodiment 6. The polyimide material according to any of the preceding embodiments, wherein at least one of A, A′, A″, and A″′ includes the halogen group.

Embodiment 7. The polyimide material according to embodiment 6, wherein at least one of A, A′, A″, and A″′ includes fluorine.

Embodiment 8. The polyimide material according to any of the preceding embodiments, wherein the polyimide material further includes at least one property selected from the following property group M and at least one property selected from the following property group O, wherein property group M includes:
(i) a tensile strength of the polyimide material as determined according to ASTM standard D897-08 of at least 2.5 GPa, at least 2.8 GPa, at least 3.0 GPa, at least 3.3 GPa, at least 3.5 GPa, at least 3.8 GPa, at least 4.0 GPa, at least 4.3 GPa, at least 4.5 GPa, at least 4.8 GPa, or at least 5.0 GPa;
(ii) a peak molecular weight as determined by size exclusion chromatography against a polystyrene standard of at least 200 kDa, at least 250 kDa, at least 300 kDa, at least 350 kDa, at least 400 kDa, at least 450 kDa, at least 500 kDa, at least 550 kDa, at least 600 kDa, at least 650 kDa, or at least 700 kDa;
(iii) an elongation at break of a film having a thickness of 25 micrometer (±5 micrometer) of the polyimide material as determined by ASTM D638-14 of not more than 20%, not more than 17%, not more than 15%, not more than 13%, not more than 10%, not more than 9.5%, not more than 9%, not more than 8.5%, not more than 8%, not more than 7.5%, not more than 7%, not more than 6.5%, not more than 6.2%, not more than 6.0%, not more than 5.8%, not more than 5.6%, not more than 5.4%, not more than 5.2%, not more than 5%, or not more than 4.8%; or
(iv) a folding endurance of a film having a thickness of 25 micrometer (±5 micrometer) of the polyimide material as determined according to ASTM D2176-16 over a pin having a radius of 1 mm of at least 10,000 folds, at least 20,000 folds, at least 50,000 folds, at least 80,000 folds, at least 100,000 folds, at least 150,000 folds, at least 180,000 folds, at least 200,000 folds, at least 250,000 folds, at least 300,000 folds, at least 500,000 folds, or at least 1,000,000 folds; and property group O includes:
(i) an optical transparency of a film having a thickness of 25 micrometer (±5 micrometer) of the polyimide material as determined by UV-Vis spectroscopy at 400 nm of at least 20%, at least 25%, at least 30%, at least 32%, at least 34%, at least 36%, at least 38%, at least 40%, at least 42%, or at least 44%;
(ii) an optical transparency of a film having a thickness of 25 micrometer (±5 micrometer) of the polyimide material as determined by UV-Vis spectroscopy at 550 nm of at least 85%, at least 86%, at least 87%, at least 88%, at least 89%, at least 90%, at least 91%, at least 92%, at least 94%, or at least 96%;
(iii) an optical transparency of a film having a thickness of 25 micrometer (±5 micrometer) of the polyimide material as determined by UV-Vis spectroscopy at 330 nm of not greater than 50%, not greater than 48%, not greater than 46%, not greater than 44%, not greater than 42%, not greater than 40%, not greater than 38%, not greater than 36%, not greater than 34%, not greater than 32%, not greater than 30%, not greater than 28%, not greater than 26%, not greater than 24%, not greater than 22%, not greater than 20%, not greater than 18%, or not greater than 16%; or
(iv) a thickness retardation Ra of not more than 200 nanometers (nm), not more than 180 nm, not more than 160 nm, not more than 140 nm, not more than 120 nm, not more than 100 nm, not more than 80 nm, not more than 60 nm, not more than 50 nm, not more than 40 nm, not more than 30 nm, not more than 28 nm, not more than 26 nm, not more than 24 nm, not more than 22 nm, or not more than 20 nm.

Embodiment 9. The polyimide material according to embodiment 8, having at least two, at least three, or at least four properties of property group M.

Embodiment 10. The polyimide material according to embodiment 8, having at least two, at least three, or at least four properties of property group O.

Embodiment 11. The polyimide material according to any of the preceding embodiments, further including an optional monomer selected from the group consisting of:

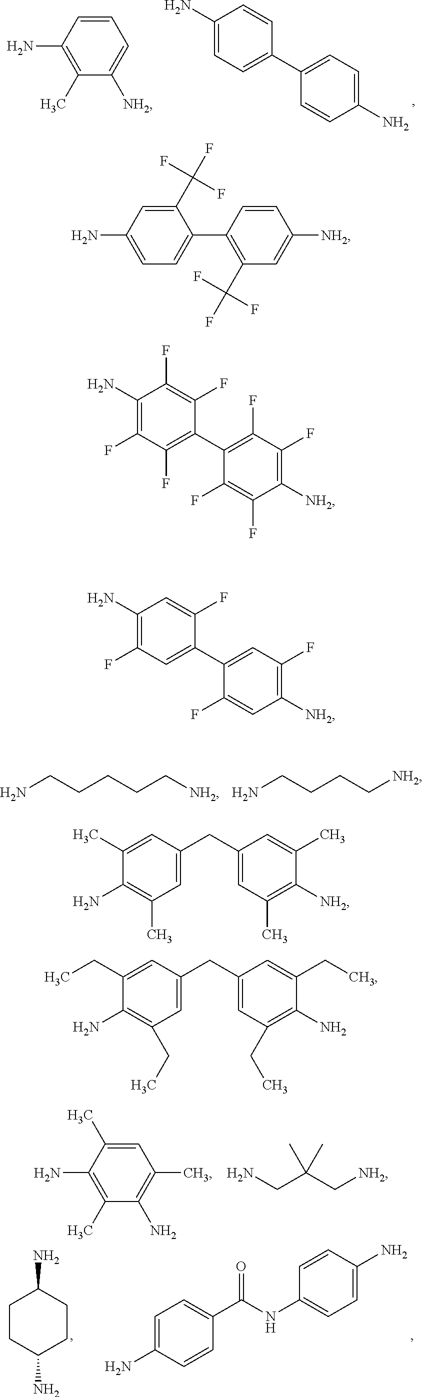

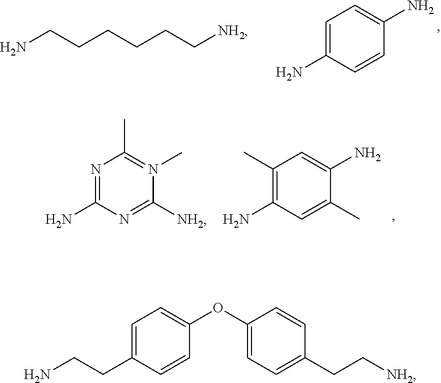

or combination thereof.

Embodiment 12. The polyimide material according to any of the preceding embodiments, further including an optional monomer selected from the group consisting of:

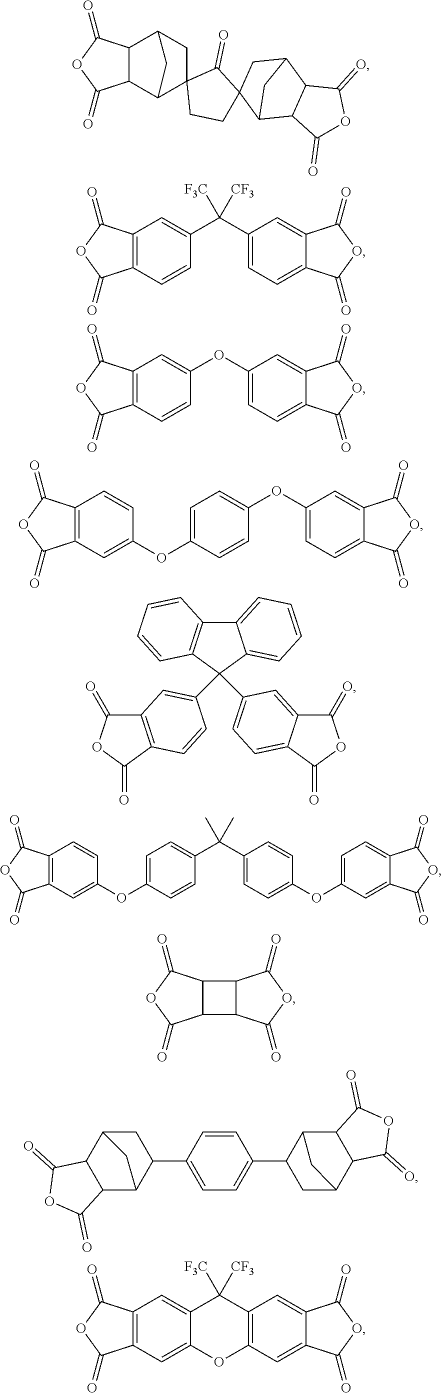

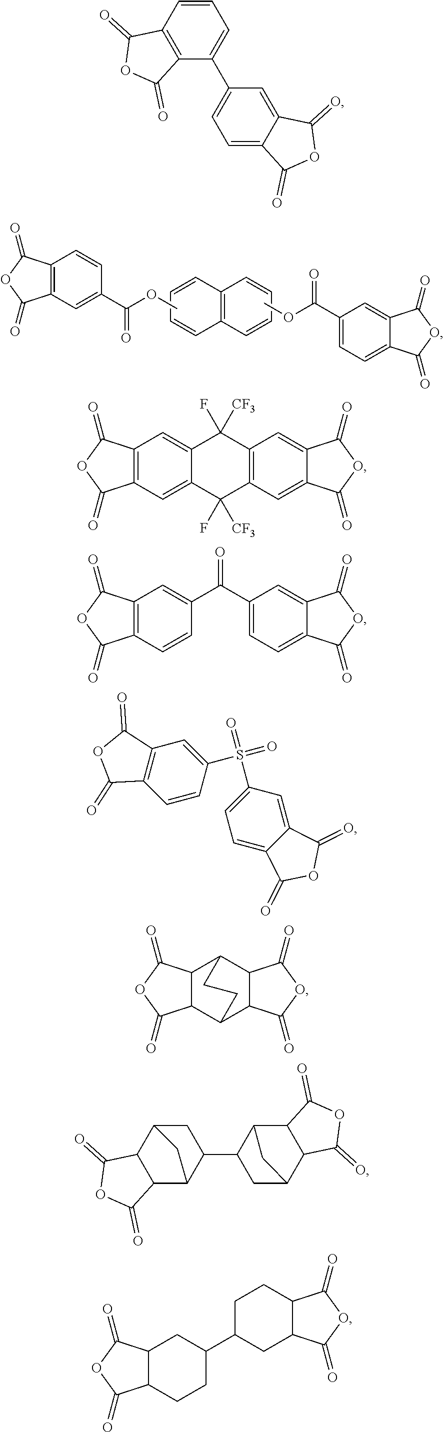

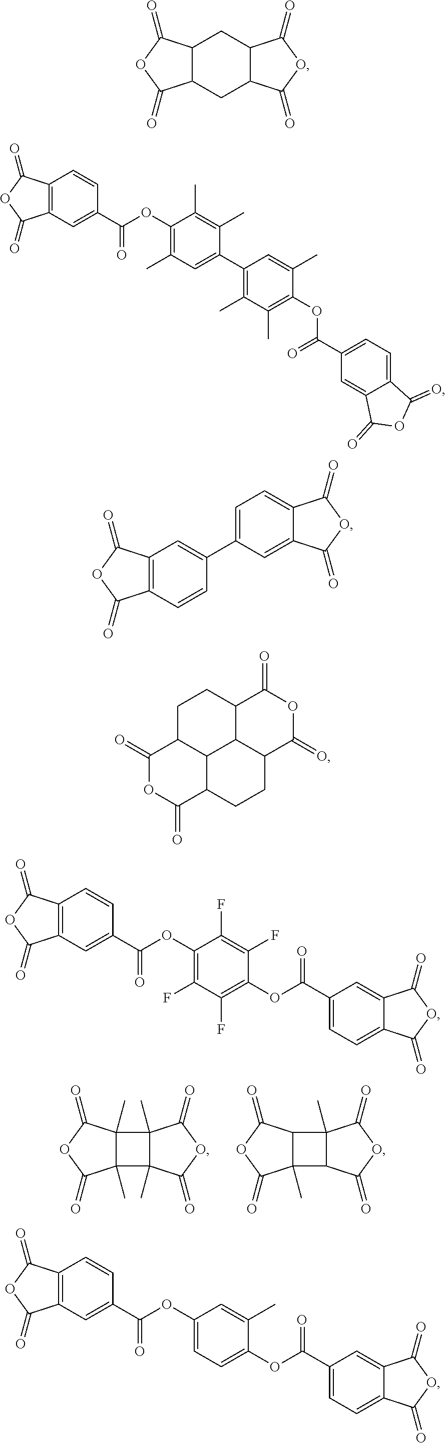

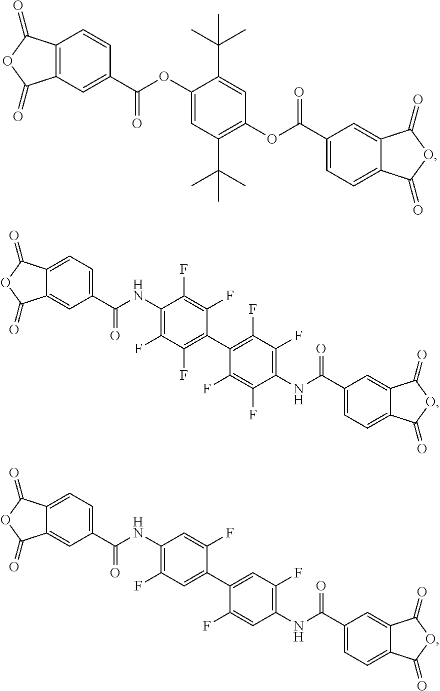 [SMILES: CC(C)(C)c1cc(OC(=O)c2ccc3c(c2)C(=O)OC3=O)c(C(C)(C)C)cc1OC(=O)c1ccc2c(c1)C(=O)OC2=O ; O=C(Nc1c(F)c(F)c(-c2c(F)c(F)c(NC(=O)c3ccc4c(c3)C(=O)OC4=O)c(F)c2F)c(F)c1F)c1ccc2c(c1)C(=O)OC2=O ; O=C(Nc1cc(F)c(-c2cc(F)c(NC(=O)c3ccc4c(c3)C(=O)OC4=O)cc2F)cc1F)c1ccc2c(c1)C(=O)OC2=O]

or combination thereof.

Embodiment 13. The polyimide material according to any of the preceding embodiments, wherein the first monomer and the second monomer are in a molar ratio ranging from 10:1 to 1:10, from 5:1 to 1:5, from 3:1 to 1:3, from 2:1 to 1:2, from 3:2 to 2:3, from 4:3 to 3:4, from 5:4 to 4:5, from 6:5 to 5:6, from 7:6 to 6:7, from 8:7 to 7:8, from 9:8 to 8:9, or from 10:9 to 9:10.

Embodiment 14. An optical stack including the polyimide material according to embodiments 1 through 13.

Embodiment 15. An electronic device including the polyimide material according to embodiments 1 through 13.

Embodiment 16. A polyimide material including a moiety selected from:

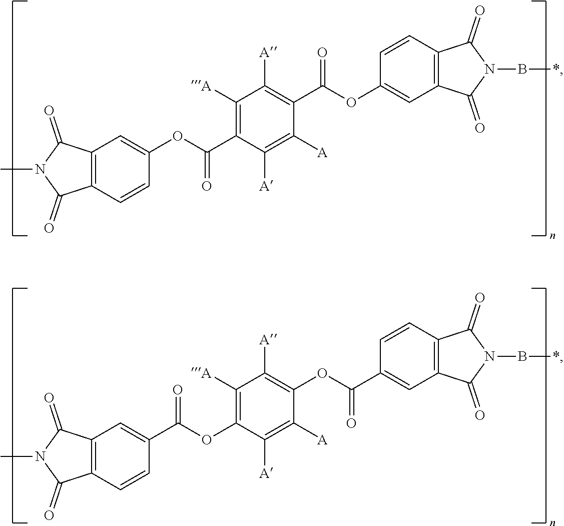

or combination thereof, wherein n is greater than 1, wherein A, A′, A″, and A″′ is independently at each occurrence a hydrogen, an alkyl, a halogen, a haloalkyl, or combination thereof, with the proviso that at least one of A, A′, A″, and A″′ includes an alkyl, a halogen, a haloalkyl, or combination thereof; and
wherein B is selected from the group consisting of:

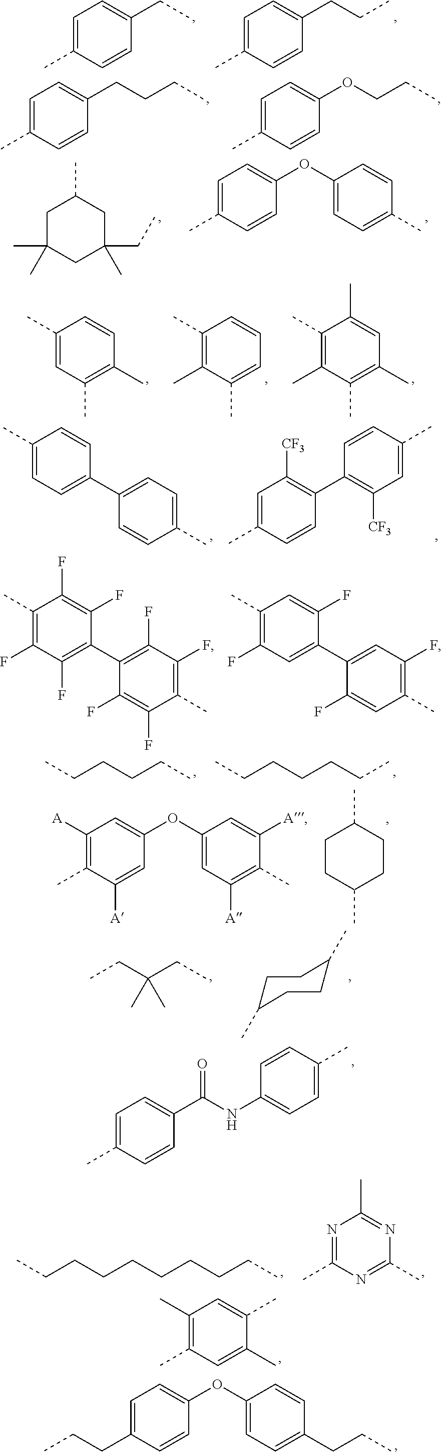

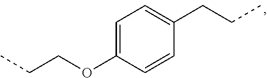

or combination thereof, wherein A, A′, A″, and A″′ is independently at each occurrence a hydrogen, an alkyl, a halogen, a haloalkyl, or combination thereof.

Embodiment 17. The polyimide material according to embodiment 16, wherein the alkyl, haloalkyl, or combination thereof includes a C1-C20 hydrocarbon group, a C1-C20 halogenated hydrocarbon group, or a C1-C20 perhalogenated group.

Embodiment 18. The polyimide material according to any of embodiments 16-17, wherein at least one of A, A′, A″, and A″′ includes an alkyl group, haloalkyl, or halogen.

Embodiment 19. The polyimide material according to any of embodiments 16-18, wherein the halogen, haloalkyl, or combination thereof includes fluorine, chlorine, bromine, iodine, or combination thereof.

Embodiment 20. The polyimide material according to any of embodiments 16-19, wherein the haloalkyl includes a C1-C20 hydrocarbon group including fluorine.

Embodiment 21. The polyimide material according to any of embodiments 16-20, wherein at least one of A, A′, A″, and A′″ includes the halogen group.

Embodiment 22. The polyimide material according to any of embodiments 16-21, wherein at least one of A, A′, A″, and A″′ includes fluorine.

Embodiment 23. The polyimide material according to any of embodiments 16-22, wherein the polyimide material has at least one property selected from the following property group M and at least one property selected from the following property group O, wherein property group M includes:
(i) a glass transition temperature as determined by thermomechanical analysis of at least 200° C., at least 210° C., at least 220° C., at least 230° C., at least 240° C., at least 250° C., at least 260° C., at least 270° C., at least 280° C., at least 290° C., at least 300° C., at least 310° C., at least 320° C., at least 330° C., at least 340° C., at least 350° C., at least 360° C., at least 370° C., at least 380° C., at least 390° C., or at least 400° C.;
(ii) a tensile modulus as determined according to ASTM standard D897-08 of at least 2.5 GPa, at least 2.8 GPa, at least 3.0 GPa, at least 3.3 GPa, at least 3.5 GPa, at least 3.8 GPa, at least 4.0 GPa, at least 4.3 GPa, at least 4.5 GPa, at least 4.8 GPa, at least 5.0 GPa, at least 5.2 GPa, at least 5.5 GPa, at least 5.8 GPa, at least 6.0 GPa, at least 6.3 GPa, at least 6.5 GPa, at least 6.8 GPa, at least 7.0 GPa, at least 7.3 GPa, or at least 7.5 GPa;
(iii) a tensile strength as determined according to ASTM standard D897-08 of at least 2.5 GPa, at least 2.8 GPa, at least 3.0 GPa, at least 3.3 GPa, at least 3.5 GPa, at least 3.8 GPa, at least 4.0 GPa, at least 4.3 GPa, at least 4.5 GPa, at least 4.8 GPa, or at least 5.0 GPa;
(iv) a peak molecular weight as determined by size exclusion chromatography against a polystyrene standard of at least 200 kDa, at least 250 kDa, at least 300 kDa, at least 350 kDa, at least 400 kDa, at least 450 kDa, at least 500 kDa, at least 550 kDa, at least 600 kDa, at least 650 kDa, or at least 700 kDa;
(v) an elongation at break of a film having a thickness of 25 micrometer (±5 micrometer) of the polyimide material as determined by ASTM D638-14 of not more than 20%, not more than 17%, not more than 15%, not more than 13%, not more than 10%, not more than 9.5%, not more than 9%, not more than 8.5%, not more than 8%, not more than 7.5%, not more than 7%, not more than 6.5%, not more than 6.2%, not more than 6.0%, not more than 5.8%, not more than 5.6%, not more than 5.4%, not more than 5.2%, not more than 5%, or not more than 4.8%; or
(vi) a folding endurance of a film having a thickness of 25 micrometer (±5 micrometer) of the polyimide material as determined according to ASTM D2176-16 at a radius of 1 mm of at least 10,000 folds, at least 20,000 folds, at least 50,000 folds, at least 80,000 folds, at least 100,000 folds, at least 150,000 folds, at least 180,000 folds, at least 200,000 folds, at least 250,000 folds, at least 300,000 folds, at least 500,000 folds, or at least 1,000,000 folds; and property group O includes:
(i) an optical transparency of a film having a thickness of 25 micrometer (±5 micrometer) of the polyimide material as determined by UV-Vis spectroscopy at 400 nm of at least 20%, at least 25%, at least 30%, at least 32%, at least 34%, at least 36%, at least 38%, at least 40%, at least 42%, or at least 44%;
(ii) an optical transparency of a film having a thickness of 25 micrometer (±5 micrometer) of the polyimide material as determined by UV-Vis spectroscopy at 550 nm of at least 85%, at least 86%, at least 87%, at least 88%, at least 89%, at least 90%, at least 91%, at least 92%, at least 94%, or at least 96%;
(iii) an optical transparency of a film having a thickness of 25 micrometer (±5 micrometer) of the polyimide material of the polyimide material as determined by UV-Vis spectroscopy at 380 nm of not greater than 50%, not greater than 48%, not greater than 46%, not greater than 44%, not greater than 42%, not greater than 40%, not greater than 38%, not greater than 36%, not greater than 34%, not greater than 32%, not greater than 30%, not greater than 28%, not greater than 26%, not greater than 24%, not greater than 22%, not greater than 20%, not greater than 18%, or not greater than 16%;
(iv) a thickness retardation R_{d} of not more than 200 nanometers (nm), not more than 180 nm, not more than 160 nm, not more than 140 nm, not more than 120 nm, not more than 100 nm, not more than 80 nm, not more than 60 nm, not more than 50 nm, not more than 40 nm, not more than 30 nm, not more than 28 nm, not more than 26 nm, not more than 24 nm, not more than 22 nm, or not more than 20 nm;
(v) a Yellow Index according to ASTM E313 of a film having a thickness of micrometer (±5 micrometer) of the polyimide material of not more than 40.0, not more than 35.0, not more than 30, not more than 25.0, not more than 20.0, not more than 15.0, not more than 10.0, not more than 8.0, not more than 5.0, not more than 4.0, not more than 3.5, not more than 3.2, not more than 3.0, not more than 2.8, not more than 2.6, not more than 2.4, not more than 2.2, not more than 2.0, not more than 1.8, not more than 1.6, or not more than 1.4; or
(vi) a haze of a film having a thickness of 25 micrometer (±5 micrometer) of the polyimide material as determined according to ASTM D1003-13 of not greater than 1.5%, not greater than 1.3%, not greater than 1.1%, not greater than 1.0%, not greater than 0.8%, not greater than 0.6%, not greater than 0.5%, not greater than 0.4%, or not greater than 0.3%.

Embodiment 24. The polyimide material according to embodiment 23, having at least two, at least three, or at least four properties of property group M or having at least two, at least three, or at least four properties of property group O.

The following examples are provided to better disclose and teach processes and compositions of the present invention. They are for illustrative purposes only, and it must be acknowledged that minor variations and changes can be made without materially affecting the spirit and scope of the invention as recited in the claims that follow.

### EXAMPLES

Polyimide material according to the present disclosure can be prepared according to a random type or controlled type procedure. In the random type procedure, all monomers and co-monomers are added to the reaction vessel prior to initiating the reaction. In the controlled type procedure, the reaction is initiated with a limited number of monomers and co-monomers and additional monomers and/or co-monomers are added at a later time.

### Example 1: Synthesis of Polyimide Film Via Thermal Imidization

Dianhydride and diamine were sometimes purified via distillation under vacuum and/or recrystallization utilizing suitable solvents at relevant temperatures. Just prior to synthesis, further drying of dianhydride powder and/or diamine powder was performed via vacuum-oven drying at relevant temperatures.

To polymerize the polyamic acid, typically 20 mmol of diamine was added to anhydrous N,N-dimethylacetamide or anhydrous N-methyl-2-pyrrolidone under an inert atmosphere and mixed into solution via overhead stirring. Dianhydride was added up to 0.9-0.95 molar equivalents of diamine and the solution was mixed until homogenous. Anhydrous solvent was added to reduce viscosity as necessary. Further dianhydride was added up to 1.00 or 1.01 molar equivalents of diamine. A final solids weight percent was generally between 5 and 25% (w/v). The polyamic acid was generally stored at −20° C. until films were cast.

The imidization of the polyamic acid was typically completed in high temperature vacuum ovens. The polyamic acid was coated via a doctor blade at 10-25 mil onto borosilicate glass slide and the glass was then dried at 100° C. for 45-60 minutes on a hot plate under atmospheric conditions. Typically, the polyamic acid film was delaminated from the glass and sandwiched between two metal frames, which was then placed into a vacuum oven and imidized at 300° C. overnight under vacuum.

### Example 2a: Synthesis of Polyimide Via Chemical Imidization

Dianhydride and diamine were sometimes purified via distillation under vacuum and/or recrystallization utilizing suitable solvents at relevant temperatures. Just prior to synthesis, further drying of dianhydride powder and/or diamine powder was performed via vacuum-oven drying at relevant temperatures.

To polymerize the polyamic acid, typically 20 mmol of diamine was added to anhydrous N,N-dimethylacetamide or anhydrous N-methyl-2-pyrrolidone under an inert atmosphere and mixed into solution via overhead stirring. Dianhydride was added up to 0.9-0.95 molar equivalents of diamine and the solution was mixed until homogenous. Anhydrous solvent was added to reduce viscosity as necessary. Further dianhydride was added up to 1.00 or 1.01 molar equivalents of diamine. A final solids weight percent was generally between 5 and 25% (w/v). Acetic anhydride in a 4-8× molar excess to dianhydride was added to the reaction and allowed to mix for 45 minutes; triethylamine or another base was then added in a 1.5-2.5× molar excess to dianhydride and mixed for 4-6 hours at 70° C. Anhydrous solvent was added to reduce viscosity as necessary. The reaction was typically precipitated into an alcohol, typically methanol and washed several times in excess ethanol/water solutions to remove residual solvent. Polymer powder was then dried in a vacuum oven overnight at 150° C. or 160° C.

### Example 2b: Synthesis of Polyimide Via Thermal Imidization

Dianhydride and diamine were sometimes purified via distillation under vacuum and/or recrystallization utilizing suitable solvents at relevant temperatures. Just prior to synthesis, further drying of dianhydride powder and/or diamine powder was performed via vacuum-oven drying at relevant temperatures.

To polymerize the polyimide, typically 20 mmol of diamine was added to m-cresol under an inert atmosphere and mixed into solution via overhead stirring. Dianhydride was added up to 1.00 or 1.01 molar equivalents of diamine and the solution was mixed until homogenous. Additional solvent was added to reduce viscosity as necessary. A final solids weight percent was generally between 5 and 25% (w/v). A catalytic quantity of isoquinoline was added to the reaction solution prior to increasing the temperature to 150° C. or 160° C. which was allowed to react for 2-4 hours. At the end of the reaction time period, the solution was precipitated into an alcohol, typically methanol and washed several times in excess ethanol/water solutions to remove residual m-cresol. Polymer was then dried in a vacuum oven overnight at 150° C. or 160° C.

### Example 2c: Casting of Polyimide Film

Polymer powders, from Example 2a and/or 2b, were dissolved into a solvent, typically N,N-dimethylacetamide or cyclopentanone, sometimes using a combination of heat and centrifugal mixing. The polyimide solution was coated via a doctor blade at 10-25 mil onto borosilicate glass slide and the glass was then dried at 100° C. for 45-60 minutes on a hot plate under atmospheric conditions. Typically, the polyimide film was delaminated from the glass and sandwiched between two metal frames, which was then placed into a vacuum oven and dried at 200° C. or 250° C. overnight under vacuum.

### Example 3: Characterization of Polyimide Films

Polymer films obtained using the methods described in Example 1 and Example 2 were characterized for their optical, thermal and mechanical properties using the following methods:

Film thickness—The thickness of a polyimide film was measured using a Mahr, 2057551 Marameter XLI-57B-15 Portable Thickness Gage. Typically, 6-21 measurements were taken across the film and the average value was reported.

Color and Optical Transparency—The optical properties (e.g. percent transmittance, color, haze, Rₜₕ) of a polyimide film was measured using spectrophotometry. The percent transmittance of the polyimide film was measured using a Shimadzu UV-2700 equipped with an integrating sphere (ISR-2600). Typically, films are inserted into a film sample holder and transmittance was measured from 800 nm to 200 nm using a slit width of 5 nm with the transmittance at 400 nm (T₄₀₀(%)) reported. The color and haze of a polyimide film was measured using an X-rite Ci7800 spectrophotometer. Typically, a film sample was placed in a 25 mm sample holder and a Class I continuous wave 532 nm laser was flashed through the sample to measure direct and total transmittance as well as haze. The average of three measurements was reported. The Rₜₕ of a polyimide film was measured using an Axometrics AxoScan™ Mueller Matrix Polarimeter. Typically, the film Rₜₕ was measured by taking two axis out-of-plane retardance measurements at 550 nm wavelength in increments of 10° up to a maximum tilt angle of 50°; several spots were measured per film and the lowest R_{d}, value was reported.

Thermal properties—Incomplete imidization, residual solvent and thermal stability T_{d}(1%) were assessed using thermogravimetric analysis utilizing a TA Instruments Discovery TGA550. Typically, a few milligrams of polymer film were placed in a TGA pan which was heated at a rate of 10° C./min to 550° C. under a nitrogen purge of 40-60 mL/min. The temperature at which 1% mass loss was achieved was recorded as the T_{d} (1%); for dry films (i.e. fully imidized, no residual solvent) this would typically occur in the 375-450° C. temperature range for these materials.

The glass transition (T_{g}) of a polyimide film was measured using dynamic mechanical analysis utilizing a TA Instruments Discovery DMA850 equipped with a film/fiber accessory. Typically, a 5×30 mm sample was die punched and loaded into the film/fiber accessory clamp; the film was heated at 5° C./min rate to 350-400° C. in a nitrogen purged atmosphere under a 0.1% strain oscillated at 1 Hz. The glass transition measurement was determined from the onset of the drop in storage modulus and/or the tan 6 maximum. The glass transition and CTE of a polyimide film was measured using thermal mechanical analysis utilizing a TA Instruments TMA Q400 with a film/fiber accessory. Typically, a 5×30 mm sample was used for testing. The sample was heated at 3° C./min to 350-400° C. under a nitrogen purge of 50 mL/min with a load of 0.5 g per film thickness in um. CTE can be calculated using the slope of the line between 100-200° C. The T_{g} was calculated by measuring the temperature at which elongation of the sample occurs.

Mechanical properties—The tensile modulus, tensile strength, and elongation at break were assessed using an Instron 5967 with a 500 N load cell. Typically, the specimens were tested following ASTM 1708. The sample dimensions follow those listed in ASTM 1708 and thickness was measured for each film utilizing a Mahr GmbH 1086Ri 25/0, 0005 mm (1″/0.00002″). Measured force and sample displacement were used by the Instron to calculate the modulus, tensile strength, and elongation at break. All measurements are from 18° C. to 25° C.

TABLE:

| | | | | | 6FDA/ | TAHQ - PDA | TAHQ - ODA | |
|---|---|---|---|---|---|---|---|---|
| | | TAHQ - | TAHQ - | TATMHQ - | TAHQ/TPC - | (from | (from | |
| | | APEA | AMA | APEA | APEA/TFMB | literature) | literature) | Kapton |
| Film | Cure | 250 C./20 hr | 250 C./20 hr | 250 C./2 hr, | Pending | 250 C./2 h | 250 C./2 h | Not |
| Properties | Temp/Time | | | 300 C./1 hr | | 350 C./1 h | 350 C./1 h | listed |
| | Thickness | 15.4 | 17.8 | 27.5 | 19.5 | 20 | 20 | 25 |
| | (μm) | | | | | | | |
| Thermal | Tg (C.) | pending | pending | 263.5 | Pending | ND | Not listed | 360-410 |
| Properties | (DMA) | | | | | | | (values |
| | (tan δ) | | | | | | | vary by |
| | | | | | | | | method) |
| | Tg (C.) | pending | 232.39 | 250.19 | Pending | ND | 320 | 360-410 |
| | (TMA) | | | | | | | (values |
| | | | | | | | | vary by |
| | | | | | | | | method) |
| | CTE | 23.843 | 69.6454 | 26.65 | Pending | 3.2 | 51.2 | 17 |
| | (ppm/C.) | | | | | | | |
| | T_{d} (5%) | 418.05 | 426.9 | 424.3 | 429.3 | 480.7 | 462.2 | Not |
| | 5% mass | | | | | | | listed |
| | loss | | | | | | | |
| Mechanical | Tensile | avg. (best | 3.39 (3.53)* | 6.75 (7.77)* | 5.99 (6.37)* | 8.86 | 2.94 | 2.76 |
| Properties | Modulus | value) | | | | | | |
| | (GPa) | 8.14 (8.38)* | | | | | | |
| | Tensile | 160 (179)* | 113 (110)* | 160.3 (191.2)* | pending | 224 | 236 | 231 |
| | Strength | | | | | | | |
| | (MPa) | | | | | | | |
| | Elongation | 4.2 (7.5)* | 14.2 (26)* | 3.59 (4.31)* | 3.29 (3.96)* | 5.4 | 67.2 | 72 |
| | at Break (%) | | | | | | | |
| Optical | T₄₀₀ (%) | 30.5 | 41.7 | 31.70 | Pending | ~23% | <1% | — |
| Properties | T₃₅₀ (%) | <1.0% | <1.0% | <1.0% | Pending | — | — | — |
| | T₆₀₀ (%) | 87.3 | 87.9 | 85.6 | Pending | — | — | — |
| | YI | 12.51 direct | 7.28 direct | 11.4 | 11.24 direct | — | — | — |
| | | 11.98 total | 7.11 total | | 8.99 total | | | |
| | Haze (%) | 1.01 | 0.73 | 3.39 | 4.20 | — | — | — |
| | Rth (nm) | 1466.611 | 301.478 | 2407 | pending | — | — | — |

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range,

What is claimed is:

1. A polyimide material obtained from a first monomer selected from the group consisting of: 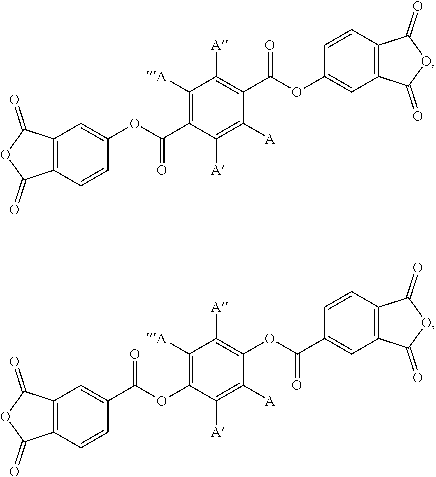
or combination thereof, wherein A, A′, A″, and A″′ is independently at each occurrence a hydrogen, an alkyl, a halogen, a haloalkyl, or combination thereof; and
a second monomer selected from the group consisting of: 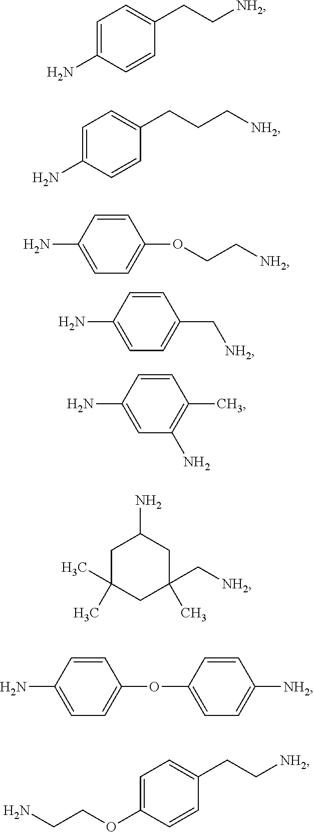
or combination thereof;
wherein the polyimide material has at least one property of:
(i) a glass transition temperature as determined by thermomechanical analysis of at least 200° C., at least 210° C., at least 220° C., at least 230° C., at least 240° C., at least 250° C., at least 260° C., at least 270° C., at least 280° C., at least 290° C., at least 300° C., at least 310° C., at least 320° C., at least 330° C., at least 340° C., at least 350° C., at least 360° C., at least 370° C., at least 380° C., at least 390° C., or at least 400° C.;
(ii) a tensile modulus as determined according to ASTM standard D897-08 of at least 2.5 GPa, at least 2.8 GPa, at least 3.0 GPa, at least 3.3 GPa, at least 3.5 GPa, at least 3.8 GPa, at least 4.0 GPa, at least 4.3 GPa, at least 4.5 GPa, at least 4.8 GPa, at least 5.0 GPa, at least 5.2 GPa, at least 5.5 GPa, at least 5.8 GPa, at least 6.0 GPa, at least 6.3 GPa, at least 6.5 GPa, at least 6.8 GPa, at least 7.0 GPa, at least 7.3 GPa, or at least 7.5 GPa;
(iii) a Yellow Index according to ASTM E313 of a film having a thickness of micrometer (±5 micrometer) of the polyimide material of not more than 40.0, not more than 35.0, not more than 30, not more than 25.0, not more than 20.0, not more than 15.0, not more than 10.0, not more than 8.0, not more than 5.0, not more than 4.0, not more than 3.5, not more than 3.2, not more than 3.0, not more than 2.8, not more than 2.6, not more than 2.4, not more than 2.2, not more than 2.0, not more than 1.8, not more than 1.6, or not more than 1.4; or
(iv) a haze as determined according to ASTM D1003-13 of a film having a thickness of 25 micrometer (±5 micrometer) of the polyimide material of not greater than 1.5%, not greater than 1.3%, not greater than 1.1%, not greater than 1.0%, not greater than 0.8%, not greater than 0.6%, not greater than 0.5%, not greater than 0.4%, or not greater than 0.3%.

2. The polyimide material according to claim 1, wherein the alkyl, haloalkyl, or combination thereof comprises a C1-C20 hydrocarbon group, a C1-C20 halogenated hydrocarbon group, or a C1-C20 perhalogenated group.

3. The polyimide material according to claim 1, wherein at least one of A, A′, A″, and A″′ comprises the alkyl group, haloalkyl, or halogen.

4. The polyimide material according to any one of claims 1 to 3, wherein the halogen, haloalkyl, or combination thereof comprises fluorine, chlorine, bromine, iodine, or combination thereof.

5. The polyimide material according to any one of claims 1 to 3, wherein the haloalkyl comprises a C1-C20 hydrocarbon group comprising fluorine.

6. The polyimide material according to any one of claims 1 to 3, wherein at least one of A, A′, A″, and A″′ comprises the halogen group.

7. The polyimide material according to claim 6, wherein at least one of A, A′, A″, and A″′ comprises fluorine.

8. The polyimide material according to any one of claims 1 to 3, wherein the polyimide material further comprises at least one property selected from the following property group M and at least one property selected from the following property group O, wherein property group M comprises:
(i) a tensile strength of the polyimide material as determined according to ASTM standard D897-08 of at least 2.5 GPa, at least 2.8 GPa, at least 3.0 GPa, at least 3.3 GPa, at least 3.5 GPa, at least 3.8 GPa, at least 4.0 GPa, at least 4.3 GPa, at least 4.5 GPa, at least 4.8 GPa, or at least 5.0 GPa;
(ii) a peak molecular weight as determined by size exclusion chromatography against a polystyrene standard of at least 200 kDa, at least 250 kDa, at least 300 kDa, at least 350 kDa, at least 400 kDa, at least 450 kDa, at least 500 kDa, at least 550 kDa, at least 600 kDa, at least 650 kDa, or at least 700 kDa;
(iii) an elongation at break of a film having a thickness of 25 micrometer (±5 micrometer) of the polyimide material as determined by ASTM D638-14 of not more than 20%, not more than 17%, not more than 15%, not more than 13%, not more than 10%, not more than 9.5%, not more than 9%, not more than 8.5%, not more than 8%, not more than 7.5%, not more than 7%, not more than 6.5%, not more than 6.2%, not more than 6.0%, not more than 5.8%, not more than 5.6%, not more than 5.4%, not more than 5.2%, not more than 5%, or not more than 4.8%; or
(iv) a folding endurance of a film having a thickness of 25 micrometer (±5 micrometer) of the polyimide material as determined according to ASTM D2176-16 over a pin having a radius of 1 mm of at least 10,000 folds, at least 20,000 folds, at least 50,000 folds, at least 80,000 folds, at least 100,000 folds, at least 150,000 folds, at least 180,000 folds, at least 200,000 folds, at least 250,000 folds, at least 300,000 folds, at least 500,000 folds, or at least 1,000,000 folds; and
property group O comprises:
(i) an optical transparency of a film having a thickness of 25 micrometer (±5 micrometer) of the polyimide material as determined by UV-Vis spectroscopy at 400 nm of at least 20%, at least 25%, at least 30%, at least 32%, at least 34%, at least 36%, at least 38%, at least 40%, at least 42%, or at least 44%;
(ii) an optical transparency of a film having a thickness of 25 micrometer (±5 micrometer) of the polyimide material as determined by UV-Vis spectroscopy at 550 nm of at least 85%, at least 86%, at least 87%, at least 88%, at least 89%, at least 90%, at least 91%, at least 92%, at least 94%, or at least 96%;
(iii) an optical transparency of a film having a thickness of 25 micrometer (±5 micrometer) of the polyimide material as determined by UV-Vis spectroscopy at 330 nm of not greater than 50%, not greater than 48%, not greater than 46%, not greater than 44%, not greater than 42%, not greater than 40%, not greater than 38%, not greater than 36%, not greater than 34%, not greater than 32%, not greater than 30%, not greater than 28%, not greater than 26%, not greater than 24%, not greater than 22%, not greater than 20%, not greater than 18%, or not greater than 16%; or
(iv) a thickness retardation Rₜₕ of not more than 200 nanometers (nm), not more than 180 nm, not more than 160 nm, not more than 140 nm, not more than 120 nm, not more than 100 nm, not more than 80 nm, not more than 60 nm, not more than 50 nm, not more than 40 nm, not more than 30 nm, not more than 28 nm, not more than 26 nm, not more than 24 nm, not more than 22 nm, or not more than 20 nm.

9. The polyimide material according to claim 8, having at least two, at least three, or at least four properties of property group M.

10. The polyimide material according to claim 8, having at least two, at least three, or at least four properties of property group O.

11. The polyimide material according to any one of claims 1 to 3, further comprising an optional monomer selected from the group consisting of: 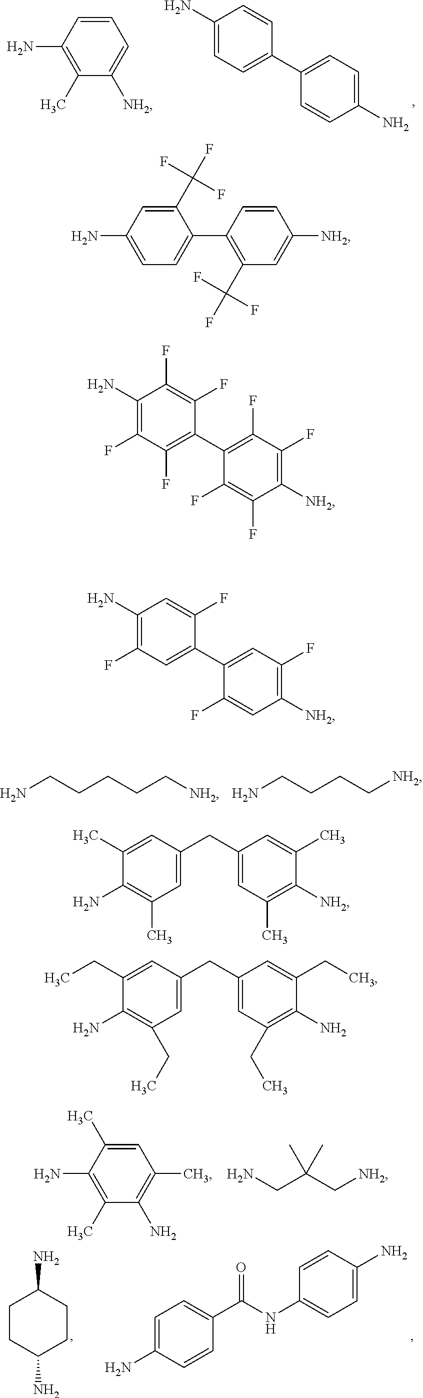 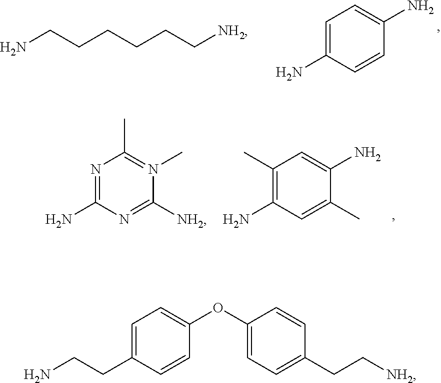
combination thereof.

12. The polyimide material according to any one of claims 1 to 3, further comprising an optional monomer selected from the group consisting of: 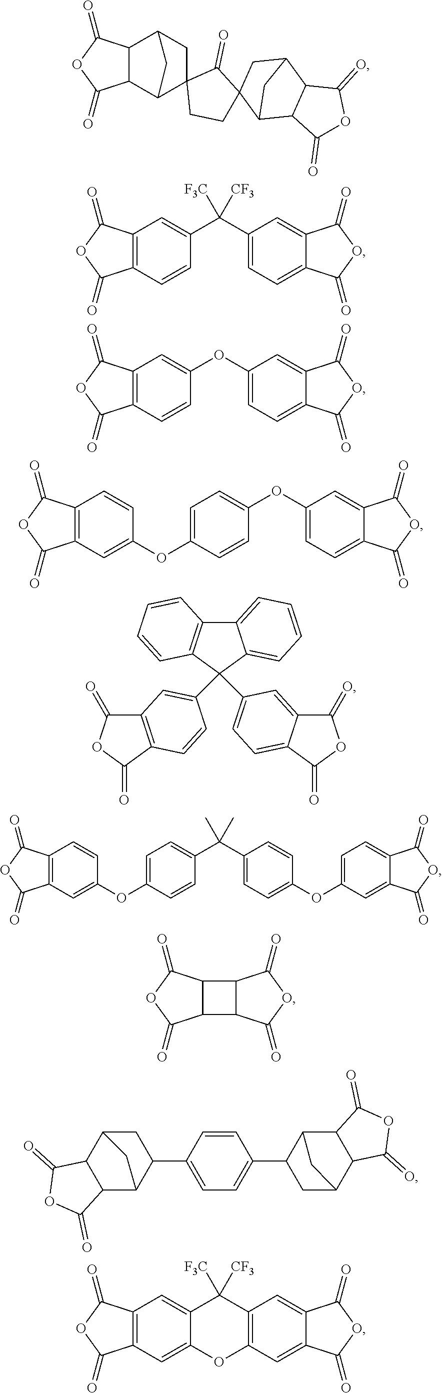 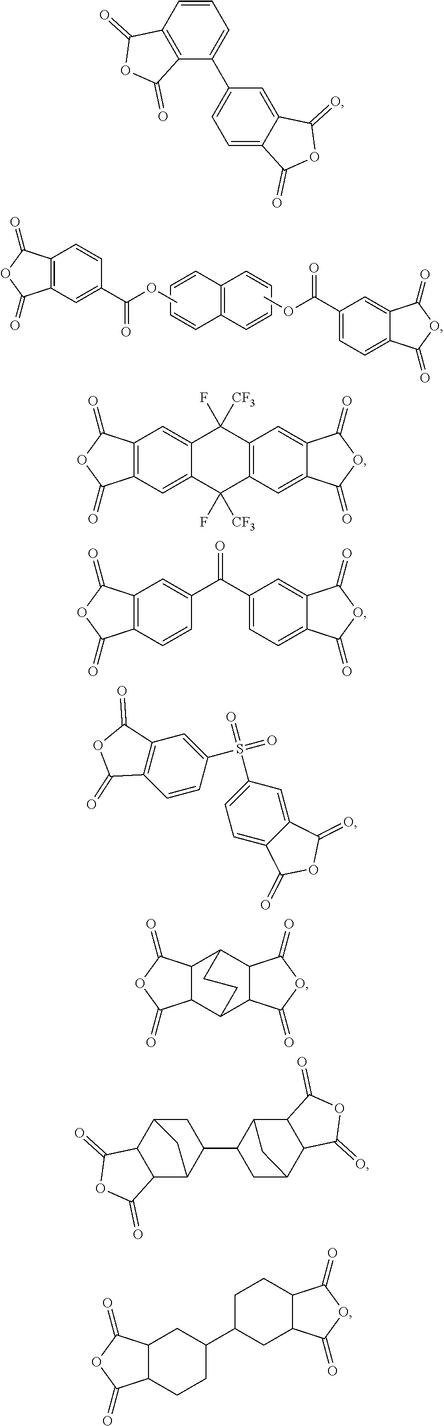 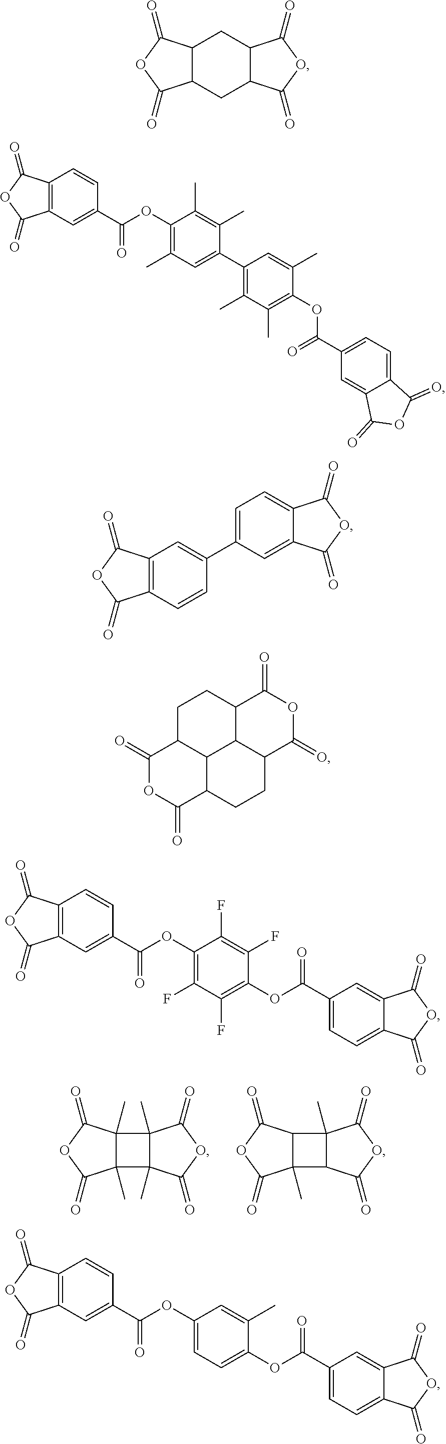 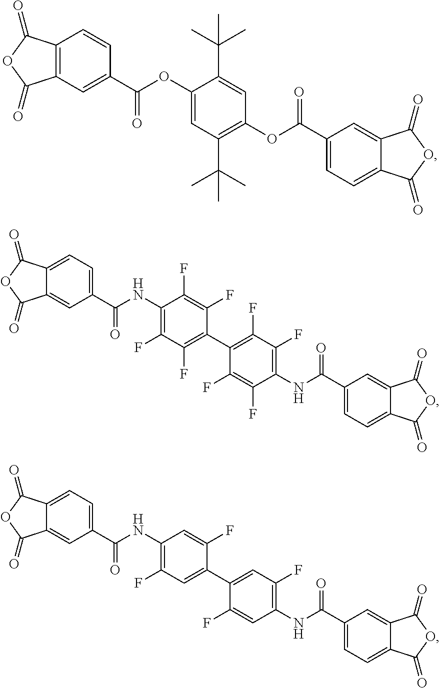 [SMILES: CC(C)(C)c1cc(OC(=O)c2ccc3c(c2)C(=O)OC3=O)c(C(C)(C)C)cc1OC(=O)c1ccc2c(c1)C(=O)OC2=O ; O=C(Nc1c(F)c(F)c(-c2c(F)c(F)c(NC(=O)c3ccc4c(c3)C(=O)OC4=O)c(F)c2F)c(F)c1F)c1ccc2c(c1)C(=O)OC2=O ; O=C(Nc1cc(F)c(-c2cc(F)c(NC(=O)c3ccc4c(c3)C(=O)OC4=O)cc2F)cc1F)c1ccc2c(c1)C(=O)OC2=O]
or combination thereof.

13. The polyimide material according to any one of claims 1 to 3, wherein the first monomer and the second monomer are in a molar ratio ranging from 10:1 to 1:10, from 5:1 to 1:5, from 3:1 to 1:3, from 2:1 to 1:2, from 3:2 to 2:3, from 4:3 to 3:4, from 5:4 to 4:5, from 6:5 to 5:6, from 7:6 to 6:7, from 8:7 to 7:8, from 9:8 to 8:9, or from 10:9 to 9:10.

14. An optical stack comprising the polyimide material according to any one of claims 1 to 3.

15. An electronic device comprising the polyimide material according to any one of claims 1 to 3.

16. A polyimide material comprising at least one moiety selected from: 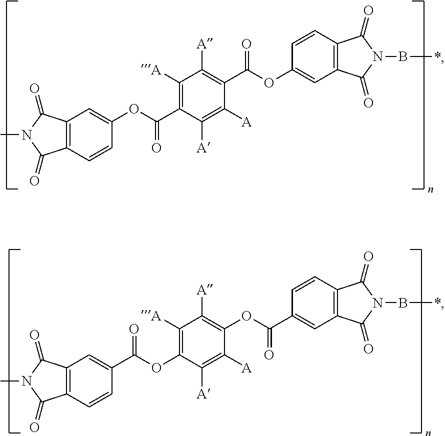
or combination thereof, wherein n is greater than 1, wherein A, A′, A″, and A″′ is independently at each occurrence a hydrogen, an alkyl, a halogen, a haloalkyl, or combination thereof, with the proviso that at least one of A, A′, A″, and A″′ comprises an alkyl, a halogen, a haloalkyl, or combination thereof; and
B is selected from the group consisting of: 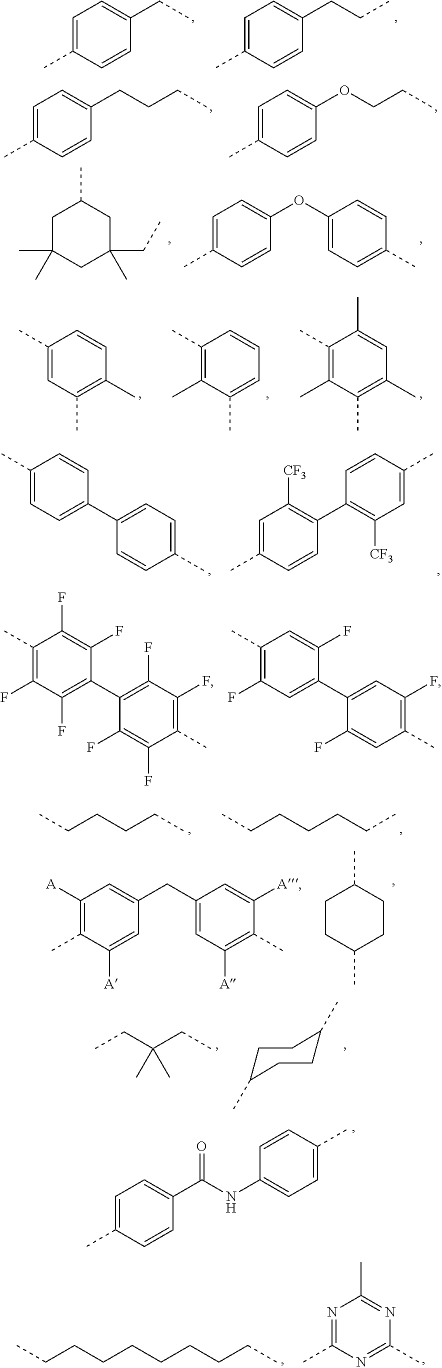 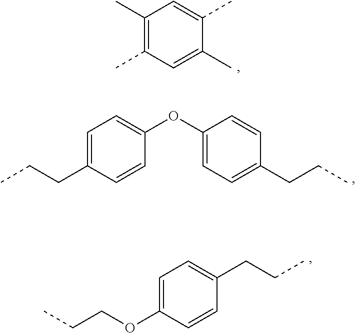
or combination thereof, wherein A, A′, A″, and A″′ is independently at each occurrence a hydrogen, an alkyl, a halogen, a haloalkyl, or combination thereof.

17. The polyimide material according to claim 16, wherein the alkyl, haloalkyl, or combination thereof comprises a C1-C20 hydrocarbon group, a C1-C20 halogenated hydrocarbon group, or a C1-C20 perhalogenated group.

18. The polyimide material according to any one of claims 16 to 17, wherein at least one of A, A′, A″, and A″′ comprises an alkyl group, haloalkyl, or halogen.

19. The polyimide material according to any one of claims 16 to 17, wherein the halogen, haloalkyl, or combination thereof comprises fluorine, chlorine, bromine, iodine, or combination thereof.

20. The polyimide material according to any one of claims 16 to 17, wherein the haloalkyl comprises a C1-C20 hydrocarbon group comprising fluorine.

21. The polyimide material according to any one of claims 16 to 17, wherein at least one of A, A′, A″, and A″′ comprises the halogen group.

22. The polyimide material according to any one of claims 16 to 17, wherein at least one of A, A′, A″, and A″′ comprises fluorine.

23. The polyimide material according to any one of claims 16 to 17, wherein the polyimide material has at least one property selected from the following property group M and at least one property selected from the following property group O, wherein property group M comprises:
(i) a glass transition temperature as determined by thermomechanical analysis of at least 200° C., at least 210° C., at least 220° C., at least 230° C., at least 240° C., at least 250° C., at least 260° C., at least 270° C., at least 280° C., at least 290° C., at least 300° C., at least 310° C., at least 320° C., at least 330° C., at least 340° C., at least 350° C., at least 360° C., at least 370° C., at least 380° C., at least 390° C., or at least 400° C.;
(ii) a tensile modulus as determined according to ASTM standard D897-08 of at least 2.5 GPa, at least 2.8 GPa, at least 3.0 GPa, at least 3.3 GPa, at least 3.5 GPa, at least 3.8 GPa, at least 4.0 GPa, at least 4.3 GPa, at least 4.5 GPa, at least 4.8 GPa, at least 5.0 GPa, at least 5.2 GPa, at least 5.5 GPa, at least 5.8 GPa, at least 6.0 GPa, at least 6.3 GPa, at least 6.5 GPa, at least 6.8 GPa, at least 7.0 GPa, at least 7.3 GPa, or at least 7.5 GPa;
(iii) a tensile strength as determined according to ASTM standard D897-08 of at least 2.5 GPa, at least 2.8 GPa, at least 3.0 GPa, at least 3.3 GPa, at least 3.5 GPa, at least 3.8 GPa, at least 4.0 GPa, at least 4.3 GPa, at least 4.5 GPa, at least 4.8 GPa, or at least 5.0 GPa;
(iv) a peak molecular weight as determined by size exclusion chromatography against a polystyrene standard of at least 200 kDa, at least 250 kDa, at least 300 kDa, at least 350 kDa, at least 400 kDa, at least 450 kDa, at least 500 kDa, at least 550 kDa, at least 600 kDa, at least 650 kDa, or at least 700 kDa;
(v) an elongation at break of a film having a thickness of 25 micrometer (±5 micrometer) of the polyimide material as determined by ASTM D638-14 of not more than 20%, not more than 17%, not more than 15%, not more than 13%, not more than 10%, not more than 9.5%, not more than 9%, not more than 8.5%, not more than 8%, not more than 7.5%, not more than 7%, not more than 6.5%, not more than 6.2%, not more than 6.0%, not more than 5.8%, not more than 5.6%, not more than 5.4%, not more than 5.2%, not more than 5%, or not more than 4.8%; or
(vi) a folding endurance of a film having a thickness of 25 micrometer (±5 micrometer) of the polyimide material as determined according to ASTM D2176-16 at a radius of 1 mm of at least 10,000 folds, at least 20,000 folds, at least 50,000 folds, at least 80,000 folds, at least 100,000 folds, at least 150,000 folds, at least 180,000 folds, at least 200,000 folds, at least 250,000 folds, at least 300,000 folds, at least 500,000 folds, or at least 1,000,000 folds; and
property group O comprises:
(i) an optical transparency of a film having a thickness of 25 micrometer (±5 micrometer) of the polyimide material as determined by UV-Vis spectroscopy at 400 nm of at least 20%, at least 25%, at least 30%, at least 32%, at least 34%, at least 36%, at least 38%, at least 40%, at least 42%, or at least 44%;
(ii) an optical transparency of a film having a thickness of 25 micrometer (±5 micrometer) of the polyimide material as determined by UV-Vis spectroscopy at 550 nm of at least 85%, at least 86%, at least 87%, at least 88%, at least 89%, at least 90%, at least 91%, at least 92%, at least 94%, or at least 96%;
(iii) an optical transparency of a film having a thickness of 25 micrometer (±5 micrometer) of the polyimide material of the polyimide material as determined by UV-Vis spectroscopy at 380 nm of not greater than 50%, not greater than 48%, not greater than 46%, not greater than 44%, not greater than 42%, not greater than 40%, not greater than 38%, not greater than 36%, not greater than 34%, not greater than 32%, not greater than 30%, not greater than 28%, not greater than 26%, not greater than 24%, not greater than 22%, not greater than 20%, not greater than 18%, or not greater than 16%;
(iv) a thickness retardation Rₜₕ of not more than 200 nanometers (nm), not more than 180 nm, not more than 160 nm, not more than 140 nm, not more than 120 nm, not more than 100 nm, not more than 80 nm, not more than 60 nm, not more than 50 nm, not more than 40 nm, not more than 30 nm, not more than 28 nm, not more than 26 nm, not more than 24 nm, not more than 22 nm, or not more than 20 nm;
(v) a Yellow Index according to ASTM E313 of a film having a thickness of micrometer (±5 micrometer) of the polyimide material of not more than 40.0, not more than 35.0, not more than 30, not more than 25.0, not more than 20.0, not more than 15.0, not more than 10.0, not more than 8.0, not more than 5.0, not more than 4.0, not more than 3.5, not more than 3.2, not more than 3.0, not more than 2.8, not more than 2.6, not more than 2.4, not more than 2.2, not more than 2.0, not more than 1.8, not more than 1.6, or not more than 1.4; or
(vi) a haze of a film having a thickness of 25 micrometer (±5 micrometer) of the polyimide material as determined according to ASTM D1003-13 of not greater than 1.5%, not greater than 1.3%, not greater than 1.1%, not greater than 1.0%, not greater than 0.8%, not greater than 0.6%, not greater than 0.5%, not greater than 0.4%, or not greater than 0.3%.

24. The polyimide material according to claim 23, having at least two, at least three, or at least four properties of property group M or having at least two, at least three, or at least four properties of property group O.
